(19) United States
(12) Patent Application Publication
(10) Pub. No.: US 2026/0023787 A1
(43) Pub. Date: Jan. 22, 2026

(54) METHODS AND SYSTEMS FOR INTELLIGENT CONVERSATIONAL ASSISTANT

(71) Applicant: Suvoda LLC, Conshohocken, PA (US)

(72) Inventors: Andrew James Lawson McVeigh, Conshohocken, PA (US); Zsolt Szigeti, Denver, PA (US); Gabriel-Marius Savastru, Conshohocken, PA (US); Raluca Maria Dumitrascu, Conshohocken, PA (US); Jadon Sargeant, Conshohocken, PA (US); Alexandru Gherega, Conshohocken, PA (US)

(21) Appl. No.: 19/272,185

(22) Filed: Jul. 17, 2025

Related U.S. Application Data
(60) Provisional application No. 63/672,515, filed on Jul. 17, 2024.

(51) Int. Cl. G06F 16/9032; G06F 16/9038; G06F 40/263; G06F 40/35; G06F 40/51; G06F 40/58

(52) U.S. Cl. CPC G06F 16/90332; G06F 16/9038; G06F 40/263; G06F 40/35; G06F 40/51; G06F 40/58

(57) ABSTRACT

Described herein are methods and systems for a conversational assistant that may be configured for use with one or more applications. The disclosed systems and methods may be configured as an outer loop/inner loop architecture incorporating one or more large language models (LLMs) and/or RAG functionality to support dialog-based interactions.

### CROSS-REFERENCE TO RELATED APPLICATION

This application claims priority to U.S. Provisional Application No. 63/672,515, filed Jul. 17, 2024, which is herein incorporated by reference in its entirety.

### BACKGROUND

Large language models (LLMs) have demonstrated remarkable capabilities in natural language processing tasks, including question answering and conversational interactions. However, their application in highly regulated industries such as healthcare and clinical trials presents significant challenges. These industries require strict adherence to data privacy regulations, unambiguous responses, and reliable audit trails. Current implementations of LLM-based conversational systems often struggle with maintaining consistency across multiple interactions and can produce unreliable or incorrect information, a phenomenon known as hallucination. This unpredictability poses risks in environments where accuracy and data integrity are paramount. Clinical applications are complex, requiring expert level domain knowledge and large amounts of and time system resources to answer questions. The use of a naïve LLMs or retrieval augmented generation (RAG) agent can make eCOA systems susceptible to risks like hallucinations and context window overload. Further, incorporating LLMs into a mission-critical, compliance-sensitive domain such as clinical trials raises challenges related to reliability, testability, scalability, and hallucination mitigation. Further, traditional systems often require domain experts or customer care teams to manually debug issues, such as failed drug shipment requests or subject randomization errors. This manual effort may create inefficiencies, introduce delays in clinical operations, and overburden limited expert resources.

Existing systems frequently encounter difficulties in scaling to handle complex, domain-specific queries without exceeding the context limitations of LLMs. This constraint restricts the depth and breadth of information that can be processed and returned in a single interaction. Another limitation of current approaches is the lack of effective mechanisms for subject matter experts to validate and control the reasoning processes of AI systems. This gap between human expertise and machine-generated responses can lead to errors or misinterpretations in specialized fields. Furthermore, many LLM-based systems do not adequately address the need for role-based access control and data protection, which are especially relevant in clinical trial management where maintaining the integrity of blinded studies is crucial.

The integration of LLM technology with existing enterprise software systems, particularly those used in clinical trials and healthcare, presents additional technical hurdles. These include ensuring seamless data flow between legacy systems and AI components while maintaining system performance and reliability. Addressing these technical challenges is essential for the development of AI-assisted conversational systems that can be safely and effectively deployed in highly regulated industries. Improvements in these areas could lead to more efficient information retrieval, enhanced decision support, and streamlined workflows in complex operational environments.

### SUMMARY

It is to be understood that both the following general description and the following detailed description are exemplary and explanatory only and are not restrictive. Described herein are systems and methods for clinical and/or pharmaceutical systems (e.g., eclinical systems, eCOA systems, epatient systems, financial systems, combinations thereof, and the like) including a conversational assistant using an LLM and agentic RAG techniques. The agentic IRT system may comprise an outer loop and an inner loop. The outer loop may be a conversational and user facing runtime component configured to receive user inputs and determine intents associated with the user inputs. The inner loop may be configured to process the intents, determine one or more preconfigured questions associated with the user query, run deterministic scripts and output answers back to the outer loop for presentation to a user. In an embodiment, the system provides a conversational AI assistant for clinical trial management and other applications that combines an outer loop for user interaction with an inner loop for executing predefined scripts. The system may utilize a question bank and authoring workbench to enable subject matter experts to create and verify deterministic scripts, reducing hallucinations. The system may incorporate validation checks, persona-based access controls, and/or multi-application support to ensure accuracy and security in complex clinical environments. Multi-application support refers to the fact that the system can be integrated with and/or support various applications including, but not limited to, eCOA systems, epatient systems, eclinical systems, financial systems, pharmaceutical manufacturing systems, pharmaceutical distribution systems, combinations thereof, and the like. That is, it is to be understood that while an exemplary embodiment may refer to, for example, an IRT application, a person skilled in the art will understand that the present methods and systems may be used with any application. The foregoing general description of the illustrative embodiments and the following detailed description thereof are merely exemplary aspects of the teachings of this disclosure and are not restrictive.

### BRIEF DESCRIPTION OF DRAWINGS

The accompanying drawings, which are incorporated in and constitute a part of this specification, together with the description, serve to explain the principles of the present methods and systems:

FIG. 1A shows an example system;

FIG. 1B shows an example process flow;

FIG. 2 shows an example system;

FIG. 3 shows an example system;

FIG. 4 shows an example system;

FIG. 5 shows an example system and process flow;

FIG. 6 show example context windows;

FIG. 7 shows example persona gates;

FIG. 8 shows an example interface;

FIG. 9 shows an example interface;

FIG. 10 shows an example interface;

FIG. 11 shows an example method;

FIG. 12 shows an example method;

FIG. 13 shows an example system; and

FIG. 14 shows an example system.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The present disclosure relates to a conversational artificial intelligence (AI) system 100. While the present disclosure is provided in the context of clinical trial management, the methods and systems are not limited to such context. The system may provide an interface for users to interact with complex clinical trial data and processes through natural language queries. In some cases, the system may comprise multiple components working in concert to interpret user queries, retrieve relevant information, and generate accurate responses.

The conversational AI system may include an outer loop component 110 for processing user input and determining user intent. In some cases, the outer loop may map user queries to predefined questions stored in a question bank in the inner loop 120 and/or authoring workbench 130. The inner loop component 120 may be configured for executing predetermined scripts (e.g., via script executor component 121) associated with the mapped questions. These scripts may call various functions to retrieve and process data from clinical trial management applications. For example, the script executor 121 may comprise an agentic LLM that has access to one or more LLM functions. The outer loop component 110 may comprise or otherwise be associated with a user interface 111, which may be a conversational user interface such as a chatbot. The user interface 111 may be configured to receive and process text input, voice input, gesture-based inputs, audio data, video data, combinations thereof, and the like.

In some cases, the system may incorporate one or more validation components (e.g., an LLM validation component 122 associated with the inner loop 120) to verify the accuracy of responses generated by the inner loop. The validation component may utilize additional AI models to cross-check the execution of scripts and the correctness of retrieved data.

The system may be designed to maintain data privacy and security in clinical trial settings. In some cases, the system may implement persona-based access controls to ensure users only access information appropriate to their role and authorization level. The system may also be configured to handle blinded and unblinded data appropriately, preventing unintentional disclosure of sensitive information. “Blinded data” may refer to any clinical trial data, metadata, or system-generated information that is restricted from being viewed or accessed by one or more categories of users (e.g., investigators, site personnel, or certain sponsor roles) in order to preserve the integrity of the trial's randomization, treatment masking, or outcome assessment. Blinded data may include, but is not limited to, subject treatment assignments, dosing schedules, shipment details, inventory levels at specific sites, or other indicators that could reveal or suggest allocation to a particular treatment arm. Access to blinded data is typically governed by trial-specific role-based access rules or persona definitions and may be enforced programmatically by filtering or masking data in responses to user queries. “Unblinded data” may refer to clinical trial data, metadata, or system-generated information that includes or reveals information about treatment assignments, dosing details, investigational product movement, or other operational data that may unmask the randomization or treatment status of trial subjects. Unblinded data may be accessible only to authorized users, such as unblinded pharmacists, drug supply managers, or designated sponsor roles, and is typically used for trial conduct, drug accountability, forecasting, or safety monitoring purposes. The system may enforce access restrictions on unblinded data through user personas, permissions frameworks, or audit-controlled function exposure

The authoring workbench 130 may be included as part of the system. This component may allow subject matter experts to define new questions and associated high level instructions (e.g., “business rules”). The terms “high level instructions” and “business rules” may be used interchangeable and generally refer to natural language instructions rather than programming language instructions. The questions (which may be referred to as “predefined questions” may be stored in the question bank 131, which may be accessed by the various components described herein). The authoring workbench may utilize AI techniques to translate high-level high level instructions into executable scripts (e.g., via script generator 132), which may then be verified by experts before being added to the system's question bank 131 (e.g., via SME validation component 133).

The conversational AI system may be designed to interact with multiple systems simultaneously. This capability may allow the system to combine data and insights from various sources to provide comprehensive responses to user queries.

In some cases, the system may incorporate mechanisms for continuous improvement and expansion of its capabilities. These mechanisms may include capturing unanswered queries for future development and allowing dynamic updates to the question bank and associated scripts without requiring software redeployment.

The conversational AI system may include an outer loop component for processing user input and determining user intent. In some cases, the outer loop component may be responsible for mapping user queries to predefined questions stored in a question bank. The outer loop component may utilize natural language processing techniques to analyze and interpret user input. In some cases, this analysis may involve tokenization, part-of-speech tagging, semantic parsing, and/or vectorization to extract key information and intent from the user's query. To handle ambiguous or incomplete user inputs, the outer loop component may implement a clarification mechanism. This mechanism may generate follow-up questions or prompts to the user, seeking additional information or context to refine the understanding of the user's intent. For example, if a user asks about drug supply without specifying a particular study or site, the outer loop component may ask for clarification on which specific study or site the user is inquiring about. The outer loop component may employ machine learning algorithms to improve its ability to map user queries to predefined questions over time. In some cases, these algorithms may analyze patterns in user interactions and feedback to refine the mapping process and enhance the system's ability to understand user intent accurately. In cases where a user's query does not directly match any predefined questions in the question bank, the outer loop component may implement a dynamic remapping process. This process may involve identifying the closest matching questions or combining multiple relevant questions to address the user's intent. The outer loop component may then construct a composite query that can be processed by the inner loop scripts. To handle complex queries that may require multiple steps or pieces of information, the outer loop component may break down the user's request into a series of sub-queries. In some cases, these sub-queries may be mapped to multiple predefined questions, with the outer loop component managing the sequence of interactions and aggregating the results to provide a comprehensive response to the user. The outer loop component may also maintain context awareness across multiple user interactions within a session. This context awareness may allow the system to interpret follow-up questions or references to previous queries without requiring the user to restate all relevant information in each interaction. In some cases, the outer loop component may incorporate a feedback mechanism to capture instances where user queries cannot be adequately mapped to existing predefined questions. This information may be used to identify gaps in the system's knowledge base and prioritize the development of new questions and associated scripts for the question bank.

The conversational AI system may include an inner loop component for executing predetermined scripts associated with mapped questions. In some cases, the inner loop component may operate in a controlled environment with a restricted and segmented chat history (which reduces token load) to maintain predefined logic flows and reduce the likelihood of generating inaccurate or inconsistent responses. The inner loop component may retrieve and execute a deterministic script corresponding to the question identified by the outer loop component. These scripts may be designed to follow a specific sequence of steps, calling predefined functions to retrieve and process data from clinical trial management applications. In some cases, the inner loop component may maintain a separate chat history for each script execution. This segmented approach may help prevent information from previous interactions or unrelated queries from influencing the current script execution, potentially reducing the risk of generating inconsistent or irrelevant responses. The inner loop component may implement strict controls on the information available during script execution. In some cases, these controls may limit the context provided to the AI model to only the information directly relevant to the current question and script. This restricted context may help ensure that the AI model focuses solely on the predefined logic flow outlined in the script. To further enhance deterministic behavior, the inner loop component may utilize a fixed set of functions with well-defined inputs and outputs. In some cases, these functions may be designed to interact with specific clinical trial management applications or data sources in a consistent manner, reducing variability in data retrieval and processing. The inner loop component may incorporate error handling mechanisms to address unexpected situations or missing data during script execution. In some cases, these mechanisms may include predefined fallback responses or the ability to request additional information from the user through the outer loop component. To maintain consistency across multiple executions of the same script, the inner loop component may implement version control for scripts and associated functions. In some cases, this versioning system may ensure that updates to scripts or underlying data sources do not inadvertently alter the behavior of existing queries without explicit review and approval. The inner loop component may also include logging and tracing capabilities to record the exact sequence of steps and function calls made during script execution. In some cases, these logs may be used for auditing purposes, performance optimization, or debugging of complex queries. To further enhance the reliability of responses, the inner loop component may implement a series of validation checks throughout the script execution process. These checks may verify the integrity of retrieved data, ensure logical consistency in intermediate results, and validate the final output before returning it to the outer loop component for presentation to the user. In some cases, the inner loop component may support parallel execution of multiple scripts or script segments when processing complex queries that require information from various sources. This parallel processing capability may help optimize response times while maintaining the integrity of individual script executions. The inner loop component may also incorporate mechanisms for handling long-running queries or scripts that exceed predefined time limits. In some cases, these mechanisms may include the ability to provide partial results, progress updates, or the option to continue processing in the background while allowing the user to perform other tasks. To adapt to variations in clinical trial configurations or study-specific requirements, the inner loop component may support parameterized scripts. These scripts may accept study-specific parameters or configuration settings, allowing the same underlying logic to be applied across different clinical trials with appropriate customizations.

The conversational AI system may include an authoring workbench component designed to facilitate the creation and management of questions and associated high level instructions by subject matter experts. This component may provide a user-friendly interface for experts to define new questions and specify the logic for answering them using natural language. In some cases, the authoring workbench may allow subject matter experts to input questions in a format similar to how end-users might phrase their queries. The workbench may also provide tools for experts to articulate the high level instructions and logic required to answer these questions accurately. The authoring workbench may incorporate a translation mechanism that utilizes a large language model to convert the natural language high level instructions into deterministic scripts. This translation process may involve analyzing the expert-provided instructions and generating a structured sequence of steps that can be executed by the system's inner loop component. To ensure the accuracy and reliability of the generated scripts, the authoring workbench may implement a verification process. In some cases, this process may allow subject matter experts to review and validate the translated scripts before they are added to the system's question bank. The verification step may include tools for experts to simulate script execution, inspect intermediate results, and make necessary adjustments to the high level instructions or generated scripts. The authoring workbench may support an iterative refinement process, allowing experts to modify and improve questions and high level instructions over time. In some cases, this iterative approach may involve analyzing user feedback, identifying common edge cases, and expanding the scope of existing questions to cover a broader range of scenarios. To enhance the system's capabilities without requiring extensive coding, the authoring workbench may incorporate a mechanism for integrating reports into the authoring loop. This feature may allow subject matter experts to define new data retrieval and processing functions based on existing reporting capabilities within the clinical trial management applications. In some cases, the report integration mechanism may provide a graphical interface for experts to construct complex queries or data aggregations using familiar clinical trial concepts and terminology. The authoring workbench may then translate these report definitions into functions that can be called by the deterministic scripts, effectively extending the system's data access and processing capabilities. The authoring workbench may include version control features to manage changes to questions, high level instructions, and generated scripts over time. In some cases, this versioning system may allow experts to track modifications, compare different versions, and roll back changes if necessary. To support collaboration among multiple subject matter experts, the authoring workbench may implement access controls and workflow management features. These features may allow organizations to define roles and permissions for different experts, manage the review and approval process for new questions and scripts, and maintain an audit trail of changes made to the system's knowledge base. The authoring workbench may also provide tools for managing the relationships between questions, high level instructions, and underlying data sources. Some of the high level instructions may be “global.” For example, the global high level instructions may be available for authoring any questions, describing rules for the entire system, etc. Some of the high level instructions may be specific to (e.g., unique to) specific predefined questions. In some cases, these tools may help experts identify dependencies between different components of the system, ensuring that updates to one area do not inadvertently impact the functionality of others. The system may be configured to perform localization by processing all high level instructions (e.g., all rules) in a canonical language (e.g., English, or any other language). The inner loop and/or outer loop may be fed a set of synonyms for business specific terms. Then, the system may respond in the same language and terminology used by a user. This capability may allow subject matter experts to create and manage localized versions of the system's knowledge base, ensuring consistent functionality across different languages and regions. The authoring workbench may incorporate testing and validation tools to help subject matter experts assess the performance and accuracy of newly created or modified questions and scripts. In some cases, these tools may allow experts to run automated tests against sample data sets, simulating various user scenarios and verifying the correctness of generated responses. To support the system's ability to handle customized clinical trial configurations, the authoring workbench may provide mechanisms for creating parameterized questions and scripts. This feature may allow experts to define flexible templates that can be adapted to specific study requirements without requiring separate implementations for each variation. The authoring workbench may also include analytics and reporting features to help subject matter experts monitor the usage and effectiveness of different questions and scripts. In some cases, these analytics may provide insights into common user queries, frequently accessed information, and areas where the system's knowledge base may need expansion or refinement.

The conversational AI system may include a validation component designed to confirm the correctness of executed scripts and ensure the accuracy of responses generated by the system. This validation component may utilize additional language models to perform cross-checks on both the inner loop script execution and the outer loop parameter passing. In some cases, the validation component may operate as a separate process that runs in parallel with the main script execution. This parallel operation may allow for real-time validation without significantly impacting the system's response time. For inner loop validation, the validation component may analyze the execution trace of the script, including the sequence of function calls, input parameters, and intermediate results. In some cases, this analysis may involve comparing the actual execution path with the expected path defined in the script, identifying any deviations or unexpected behaviors. The validation component may employ a separate language model, distinct from the one used in the main script execution, to interpret the execution trace and assess its correctness. In some cases, this separate model may be specifically trained or fine-tuned for validation tasks, enhancing its ability to detect subtle inconsistencies or errors in script execution. To validate outer loop parameter passing, the validation component may examine the mapping between user queries and selected questions from the question bank. In some cases, this examination may involve verifying that the extracted parameters accurately reflect the user's intent and are appropriate for the chosen question. The validation component may implement a scoring system to quantify the confidence level of its validation results. In some cases, this scoring system may take into account factors such as the complexity of the query, the number of function calls involved, and the consistency of intermediate results. In cases where the validation component detects potential issues or inconsistencies, it may trigger a review process. This process may involve flagging the response for human expert review, initiating an automated retry with modified parameters, or generating an explanation of the detected issue for the user. The validation component may maintain a log of all validation checks performed, including the results and any issues detected. In some cases, this log may be used for auditing purposes, system performance analysis, and continuous improvement of the validation process. To enhance the robustness of the validation process, the validation component may employ multiple validation strategies in parallel. These strategies may include syntactic checks, semantic analysis, and consistency verification across different data sources or related queries. The validation component may adapt its validation approach based on the specific type of query or script being executed. In some cases, this adaptation may involve applying more stringent checks for queries involving sensitive clinical data or complex calculations, while using lighter validation for simpler informational queries. To improve its effectiveness over time, the validation component may incorporate a feedback loop. This feedback loop may allow the system to learn from past validation results, refining its ability to detect and prevent errors in future script executions. In some cases, the validation component may provide detailed explanations of its validation process and results. These explanations may be made available to system administrators or subject matter experts for review, helping to build trust in the system's decision-making process and facilitating continuous improvement of the validation mechanisms.

The conversational AI system may include the question bank component 131 for storing and managing predefined questions, associated low-level scripts, and function metadata. In some cases, the question bank may serve as a centralized repository for the system's knowledge base, enabling efficient retrieval and execution of scripts in response to user queries. The question bank may be structured as a database or data store with entries for each predefined question. In some cases, each entry may contain multiple fields, including the question text, associated low-level script, and metadata describing the functions required to execute the script. The low-level scripts stored in the question bank may be deterministic sequences of instructions that specify the exact steps and function calls required to answer a particular question. In some cases, these scripts may be generated through the authoring workbench process and validated by subject matter experts before being added to the question bank. Function metadata may be made available and functions may be classified into one or more groups (e.g., “depot related functions,” “drug related functions,” etc., . . . ). During the authoring phase (as described below), a user may select one or more groups of functions to be available to generate the one or more predetermined scripts, which may be stored alongside each question may provide detailed information about the functions referenced in the associated script. In some cases, this metadata may include function names, input parameters, expected output formats, and any constraints or prerequisites for function execution. The question bank may implement versioning mechanisms to track changes to questions, scripts, and function metadata over time. In some cases, this versioning system may allow the conversational AI system to maintain compatibility with different versions of underlying clinical trial management applications or to support multiple variants of a question for different study configurations. To facilitate efficient querying and retrieval, the question bank may incorporate indexing and search capabilities. In some cases, these features may enable rapid matching of user queries to relevant predefined questions during the outer loop processing stage. The conversational AI system may include a test harness component designed to validate the functionality and accuracy of the question bank contents. In some cases, the test harness may operate on a sandboxed instance of the system, allowing for comprehensive testing without impacting live clinical trial data or operations. The test harness may be capable of executing specific questions from the question bank against predefined test datasets. In some cases, these datasets may be designed to cover a wide range of scenarios and edge cases, ensuring thorough validation of the system's response generation capabilities. To validate the output of executed questions, the test harness may implement a set of predefined validation rules or expected results. In some cases, these validation criteria may be defined by subject matter experts and stored alongside the questions in the question bank. The test harness may support automated execution of test suites, allowing for regular regression testing of the entire question bank. In some cases, this automated testing process may be integrated into the system's development and deployment pipeline, ensuring that updates to questions, scripts, or underlying functions do not introduce unintended behavior. In addition to validating individual question outputs, the test harness may assess the overall performance and consistency of the system. In some cases, this assessment may include metrics such as response time, accuracy of generated answers, and appropriate handling of error conditions or unexpected inputs. The test harness may generate detailed reports on the results of its validation processes. In some cases, these reports may highlight any discrepancies between expected and actual outputs, providing valuable feedback for system administrators and subject matter experts to refine and improve the question bank contents. To support the testing of questions that rely on external data sources or functions, the test harness may incorporate mock objects or simulated environments. In some cases, these mocked components may allow for controlled testing of complex scenarios without requiring access to live clinical trial systems. The test harness may also include mechanisms for testing the system's handling of different user personas and access control restrictions. In some cases, this feature may ensure that the question bank and associated scripts correctly enforce data privacy and security requirements across various user roles and authorization levels. To facilitate continuous improvement of the question bank, the test harness may support the addition of new test cases based on real-world usage patterns or identified edge cases. In some cases, this adaptive testing approach may help ensure that the system remains robust and accurate as it evolves to meet changing clinical trial management needs.

The conversational AI system may implement a segmented approach to handling interactions, which may enhance scalability and maintain context window constraints for large language models (LLMs). This approach may involve separate processing for outer loop, inner loop, and authoring interactions, each with its own dedicated context window.

In some cases, the outer loop component may operate within a context window that primarily contains metadata about available questions in the question bank. This metadata may include brief descriptions of each question's purpose and required parameters. By limiting the outer loop context to this high-level information, the system may efficiently map user queries to appropriate questions without exceeding LLM token limits. This allows the system to have many support questions and reduces response time (e.g., responses are generated and output more quickly).

The inner loop component may utilize a separate context window focused on executing specific scripts associated with selected questions. In some cases, this inner loop context may contain only the relevant script instructions and function metadata required for the current query. This targeted approach may allow the system to process complex queries without accumulating unnecessary context from previous interactions or unrelated questions. For the authoring process, the system may employ a dedicated context window that includes detailed information about available functions, data models, and high level instructions. In some cases, this authoring context may be larger than the runtime contexts, allowing subject matter experts to work with comprehensive information when creating or modifying questions and scripts. The segmented approach may enable the system to scale to a large number of supported questions and functions without overwhelming the LLM's context window limitations. In some cases, as new questions or functions are added to the system, only the relevant context windows may need to be updated, rather than requiring a complete reconfiguration of the entire system. To further enhance scalability, the system may implement dynamic loading of context information. In some cases, this may involve selectively loading only the most relevant question metadata or function descriptions based on the current user query or authoring task. This dynamic approach may allow the system to support an extensive knowledge base while maintaining efficient use of available context window space.

The system may also incorporate mechanisms for context pruning and summarization. In some cases, these mechanisms may analyze the relevance and importance of information within each context window, removing or condensing less critical details to make room for new information. This adaptive management of context may help maintain system performance as the knowledge base grows over time.

To support dynamic updates without requiring new software deployment, the system may implement a modular architecture for managing questions, scripts, and function definitions. In some cases, this architecture may allow for the addition or modification of individual components without affecting the overall system structure or requiring a full redeployment. The system may include a centralized repository for storing and managing questions, scripts, and function metadata. In some cases, this repository may support version control and dynamic loading, allowing updates to be pushed to the system in real-time without disrupting ongoing operations. To ensure consistency across different components of the system, a synchronization mechanism may be implemented. In some cases, this mechanism may coordinate updates between the outer loop, inner loop, and authoring components, ensuring that all parts of the system are working with the most up-to-date information and functionality.

The system may also incorporate a caching layer to optimize performance and reduce the frequency of context window updates. In some cases, this caching mechanism may store frequently accessed question metadata, script instructions, or function definitions, allowing for rapid retrieval without repeatedly loading information into the LLM context window.

To manage the potential growth of the question bank and associated scripts, the system may implement a hierarchical organization structure. In some cases, this structure may group related questions and functions into categories or domains, allowing for more efficient navigation and context management within specific areas of expertise.

The system may also include mechanisms for monitoring and analyzing context window usage across different components. In some cases, this analysis may provide insights into potential bottlenecks or areas where context management can be further optimized, allowing for continuous improvement of the system's scalability and performance.

The conversational AI system may be designed to interact with multiple distinct clinical trial management applications within the same conversational session. This multi-application support may allow the system to combine data and insights from various sources to provide comprehensive responses to user queries. In some cases, the system may maintain separate connections to different clinical trial management applications, such as interactive response technology (IRT) systems, electronic clinical outcome assessment (eCOA) platforms, and patient payment management tools. The system may be capable of routing specific parts of a user query to the appropriate application based on the nature of the information requested. The system may implement a unified interface for interacting with these diverse applications. This unified interface may abstract away the complexities of individual application APIs, presenting a consistent set of functions that can be called by the system's scripts regardless of the underlying data source. To facilitate seamless integration of data from multiple applications, the system may employ a data harmonization layer. This layer may be responsible for normalizing data formats, reconciling terminology differences, and resolving potential conflicts or inconsistencies between information retrieved from different sources. In some cases, the system may support cross-application queries that require data from multiple sources to generate a comprehensive response. For example, a query about patient compliance may involve retrieving scheduling information from an IRT system, outcome data from an eCOA platform, and payment records from a patient management system. The multi-application support may extend to the system's authoring capabilities. Subject matter experts may be able to create questions and scripts that leverage data and functionality from multiple applications, enabling more complex and insightful analyses. To ensure data privacy and security across multiple applications, the system may implement persona-based access controls. These controls may govern what information a user can access and what actions they can perform based on their role and authorization level.

In some cases, the system may define a set of personas that correspond to different roles within clinical trial management, such as site coordinators, data managers, or drug supply managers. Each persona may be associated with specific permissions and data access rules across the various integrated applications. The persona-based access controls may be enforced at multiple levels within the system. At the outer loop level, the system may filter the available questions based on the user's persona, ensuring that users are only presented with queries relevant to their role and authorization level. During script execution in the inner loop, the persona information may be passed along with function calls to the underlying applications. This may allow each application to apply its own access control rules, returning only the data that the user is authorized to view. In some cases, the system may implement dynamic persona assignment, where a user's effective permissions may change based on the context of their query or the specific study they are working on. This dynamic approach may allow for flexible access control that adapts to the complex and changing roles often found in clinical trial management.

The system may include mechanisms for handling blinded and unblinded data access. For personas associated with blinded roles, the system may automatically apply filters or transformations to retrieved data, ensuring that potentially unblinding information is not disclosed.

To support auditability and compliance, the system may maintain detailed logs of all data access and actions performed through the conversational interface. These logs may include information about the user's persona, the applications accessed, and the specific data retrieved or modified. The conversational AI system may incorporate a self-awareness feature that provides users with information on available query functionalities based on their persona and the configurations of the connected applications. This feature may allow users to understand the scope of questions they can ask and the data they can access. In some cases, the self-awareness feature may generate a dynamic menu of available query topics or categories based on the user's current persona and the state of the connected applications. This menu may be updated in real-time as the user's context changes or as new functionalities are added to the system. The system may also provide explanations for why certain queries or data may not be available to a user based on their current persona. These explanations may help users understand the boundaries of their access and direct them to appropriate channels if they require additional information or permissions.

To ensure consistency across multiple applications and personas, the system may implement a centralized policy management component 134. This component may allow administrators to define and update access control rules, persona definitions, and application integration settings in a unified manner.

The multi-application support and persona-based access controls may be designed to be extensible, allowing for the integration of new applications and the definition of new personas as clinical trial management processes evolve. This extensibility may ensure that the conversational AI system can adapt to changing requirements and technological advancements in the field of clinical research.

The conversational AI system may incorporate multilingual support and keyword localization features to ensure that responses are tailored to user-selected languages and specific terminologies. This capability may allow the system to provide consistent functionality and accurate information across different languages and regions while maintaining a centralized approach to keyword management. In some cases, the system may maintain a centralized repository of keywords and their translations across multiple languages and/or terminologies. For example, different pharmaceutical companies may use different terminology (e.g., a first pharmaceutical company may refer to “patients” while a second pharmaceutical company may refer to “subjects”). This repository may serve as a single source of truth for terminology used throughout the clinical trial management process, ensuring consistency in communication across different languages, terminologies (e.g., company, application, or industry specific terminologies) and regions. The system may implement a dynamic language or terminology selection mechanism that allows users to specify their preferred language or terminology for interactions. In some cases, this preference may be set at the user profile level or adjusted on a per-session basis, providing flexibility for multilingual users, those working in diverse linguistic environments, and/or across industry or company specific lexicons.

To support multilingual interactions, the system may employ machine translation techniques integrated with its natural language processing capabilities. In some cases, this integration may allow the system to accurately interpret user queries in various languages and generate responses in the user's preferred language while maintaining the semantic integrity of the clinical trial terminology. The system may incorporate context-aware translation mechanisms that take into account the specific domain of clinical trial management. In some cases, these mechanisms may utilize specialized medical and pharmaceutical dictionaries to ensure accurate translation of technical terms and concepts across languages. To handle variations in terminology across different clinical trials or regions, the system may implement a flexible keyword mapping system. This system may allow for the definition of study-specific or region-specific terminology mappings that can be applied dynamically based on the context of the user's query and their associated study or location. In some cases, the system may support the creation and management of language-specific variations of questions in the question bank. This capability may allow subject matter experts to craft nuanced versions of questions that account for linguistic and cultural differences while maintaining consistency in the underlying logic and data retrieval processes. The system may implement a mechanism for handling language-specific formatting requirements, such as date formats, number separators, or units of measurement. In some cases, this mechanism may automatically adjust the presentation of data based on the user's language preferences and regional settings. To ensure the accuracy of multilingual responses, the system may incorporate language-specific validation checks as part of its response generation process. In some cases, these checks may verify that translated content maintains the intended meaning and adheres to any regulatory or compliance requirements specific to the target language or region. The system may provide tools for managing and updating multilingual content, including question texts, response templates, and user interface elements. In some cases, these tools may support collaborative workflows that allow subject matter experts and translators to work together in maintaining and improving the system's multilingual capabilities. To handle scenarios where direct translation may not be appropriate or sufficient, the system may support the definition of language-specific alternative phrasings or explanations for complex concepts. In some cases, this feature may allow the system to provide culturally appropriate explanations or examples that resonate better with users in specific linguistic contexts. The multilingual support may extend to the system's reporting and documentation capabilities. In some cases, the system may be able to generate reports or export data in multiple languages, ensuring that outputs are accessible and understandable to stakeholders across different regions. To facilitate continuous improvement of its multilingual capabilities, the system may implement feedback mechanisms that allow users to report issues with translations or suggest improvements. In some cases, this feedback may be used to refine the system's translation models and terminology mappings over time. The system may also support the localization of its user interface elements, including buttons, labels, and help text. In some cases, this localization may be managed through a centralized configuration system, allowing for efficient updates and maintenance of the user interface across multiple languages. To ensure compliance with regulatory requirements in different regions, the system may incorporate language-specific rules and validations into its processing logic. In some cases, these rules may govern aspects such as data privacy notifications, consent language, or region-specific reporting requirements.

The conversational AI system may incorporate auditing and feedback mechanism 123 to enhance its functionality, ensure compliance, and facilitate continuous improvement. These mechanisms may provide valuable insights into system performance, user interactions, and areas for potential expansion. In some cases, the system may maintain detailed logs of all conversational interactions. These logs may capture the full sequence of user queries, system responses, and any intermediate processing steps. The logs may include timestamps, user identifiers, and contextual information such as the user's persona and the specific clinical trial or study associated with the interaction. The system may implement a structured logging format that allows for efficient storage and retrieval of interaction data. In some cases, this format may include separate fields for raw user input, processed queries, matched questions from the question bank, executed scripts, and generated responses. This structured approach may facilitate easier analysis and validation of the system's performance over time. To ensure the integrity and non-repudiation of the logs, the system may employ cryptographic techniques such as digital signatures or hash chains. In some cases, these techniques may provide a tamper-evident record of all interactions, supporting the system's use in regulated environments that require strict audit trails. The system may include tools for retrospective analysis of the interaction logs. In some cases, these tools may allow authorized personnel to review specific conversations, trace the system's decision-making process, and verify the accuracy of provided information. This capability may be particularly valuable for quality assurance processes or in response to regulatory inquiries. In some cases, the system may implement automated analysis of the interaction logs to identify patterns, trends, or anomalies. This analysis may provide insights into common user queries, frequently accessed information, or areas where the system's responses may need improvement. The results of this analysis may be used to prioritize updates to the question bank or to refine the system's natural language processing capabilities.

The conversational AI system may also incorporate a feedback mechanism for capturing unanswered or inadequately answered user queries. In some cases, this mechanism may be triggered when the system is unable to map a user's input to an existing question in the question bank, or when the confidence level of the system's response falls below a predefined threshold. When an unanswered query is detected, the system may log the specific user input along with relevant contextual information. In some cases, this information may include the user's persona, the current state of the conversation, and any related questions or topics that the system considered but ultimately deemed insufficient to answer the query. The feedback mechanism may include a user-facing component that allows users to explicitly flag responses as unsatisfactory or to indicate that their question was not fully answered. In some cases, this component may provide users with the option to provide additional details or clarifications about their query, which may be valuable for future system improvements. The system may aggregate and categorize the captured unanswered queries to identify common themes or areas where the system's knowledge base may need expansion. In some cases, this aggregation process may involve natural language processing techniques to cluster similar queries and identify underlying intents or concepts that are not currently covered by the system. To facilitate the review and prioritization of unanswered queries, the system may generate periodic reports summarizing the feedback received. In some cases, these reports may be automatically distributed to relevant stakeholders, such as subject matter experts or system administrators, who can use the information to guide future enhancements to the question bank and underlying knowledge base. The feedback mechanism may be integrated with the system's authoring workbench, allowing subject matter experts to directly access and review unanswered queries when developing new questions or refining existing ones. In some cases, this integration may streamline the process of expanding the system's capabilities based on real-world usage patterns and user needs. In some cases, the system may implement a closed-loop process for addressing captured feedback. This process may involve tracking the status of each unanswered query, from initial capture through analysis, development of new capabilities, and eventual resolution. This approach may help ensure that valuable user feedback is systematically addressed and incorporated into system improvements.

The auditing and feedback mechanisms may be designed with scalability in mind, capable of handling large volumes of interaction data and user feedback across multiple clinical trials and applications. In some cases, the system may employ distributed storage and processing techniques to manage the potentially high volume of log data and feedback entries generated during normal operation.

To protect user privacy and comply with data protection regulations, the system may implement data anonymization or pseudonymization techniques when storing and processing interaction logs and feedback data. In some cases, these techniques may allow for meaningful analysis and system improvement while minimizing the risk of exposing sensitive personal or clinical information.

The system may also provide configurable retention policies for interaction logs and feedback data. In some cases, these policies may allow organizations to define appropriate data retention periods based on regulatory requirements, internal policies, or the specific needs of different clinical trials or studies.

The conversational AI system for clinical trial management may integrate multiple components to provide a comprehensive solution for processing user queries and generating accurate responses. This integration may enable seamless interaction between various modules, allowing for efficient handling of complex clinical trial data and processes.

In some cases, an example system workflow 140 may begin with the outer loop component receiving a user query at 141. The outer loop may utilize natural language processing techniques to analyze the input and determine the user's intent. This process may involve tokenization, semantic parsing, and intent classification to map the query to one or more predefined questions stored in the question bank.

The outer loop component may interact with the persona-based access control module to ensure that the user has appropriate permissions for the requested information. In some cases, this interaction may involve verifying the user's role and authorization level before proceeding with query processing.

Optionally, and if necessary, at 141.5, the user intent may be clarified and/or one or more parameters associated with the user input may be determined, revised, refined, updated etc. as described herein.

Once the user's intent has been determined and permissions verified, the outer loop may pass control to the inner loop component. The inner loop may retrieve the corresponding low-level script associated with the matched question from the question bank (e.g., at 142). In some cases, the inner loop may also load relevant function metadata required for script execution.

During script execution (e.g., at 143), the inner loop may interact with multiple clinical trial management applications through a unified interface. This interface may abstract the complexities of individual application APIs, allowing the system to retrieve and combine data from various sources seamlessly. The data harmonization layer may normalize information from different applications, ensuring consistency in the processed results.

As the script executes, the validation component may operate in parallel, analyzing the execution trace and intermediate results. In some cases, the validation component may employ a separate language model to cross-check the correctness of the script execution and data retrieval processes.

The system may utilize the segmented approach to context management throughout the workflow. This approach may allow each component to operate within its own context window, optimizing the use of available tokens and maintaining scalability as the knowledge base grows.

Upon completion of script execution and validation, the inner loop may generate a response (e.g., at 144) based on the retrieved and processed data. This response may then be passed back to the outer loop for final formatting and presentation to the user (e.g., at 145).

Throughout the interaction, the system may maintain detailed logs of all operations performed. These logs may capture user inputs, matched questions, executed scripts, and generated responses. In some cases, the logging mechanism may integrate with the feedback capture system to identify and record instances of unanswered or inadequately answered queries.

The multilingual support and keyword localization features may be applied at various stages of the workflow. In some cases, these features may influence query interpretation in the outer loop, script execution in the inner loop, and response generation and formatting.

The authoring workbench may operate alongside the main conversational workflow, allowing subject matter experts to continuously refine and expand the system's capabilities. Updates made through the authoring workbench may be dynamically integrated into the question bank and function definitions, potentially impacting future query processing without requiring system downtime.

The test harness may periodically validate the entire system's functionality by executing predefined test cases against a sandboxed instance. This ongoing testing process may help ensure the reliability and accuracy of the system as it evolves over time.

By integrating these components, the conversational AI system may provide a robust and flexible solution for managing complex clinical trial queries. The system's modular architecture may allow for future expansions and adaptations to meet evolving needs in clinical trial management.

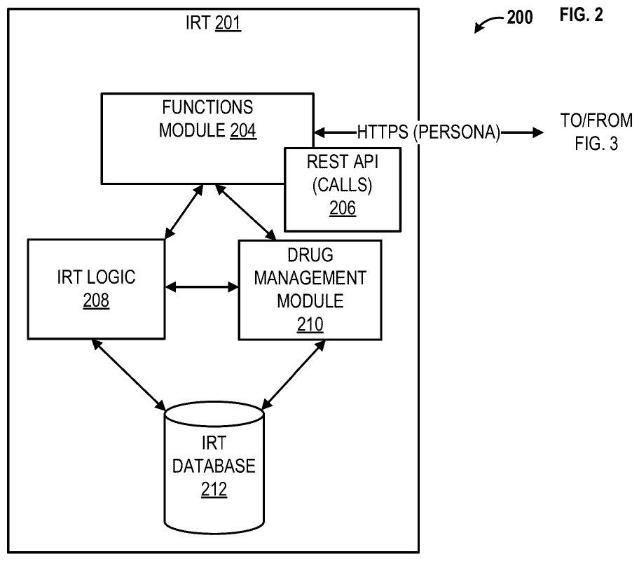

FIG. 2 shows an example system 200. The example system 200 may be a component of, or a subsystem of, the one or more systems described herein. The system 200 may comprise an Interactive Response Technology (IRT) system 201. It is to be understood that while the example FIG. 200 refers to an IRT system 201, IRT 201 is merely exemplary and explanatory and a person skilled in the art will understand that any application with functionality similar to that described with respect to IRT 201 may be incorporated into the present systems and methods The system 200 may make up part of the “inner loop” of the systems and methods described herein. For example, the system 200 may comprise one or more backend modules configured to determine data based on one or more user queries and/or prompts.

The system 200 may be configured to provide an intelligent, scalable, and reliable architecture for integrating a large language model (LLM)-powered assistant into Interactive Response Technology (IRT) environments. The system may be configured to enable clinical users to interact conversationally with IRT services to obtain information, diagnose system behavior, and potentially trigger system actions, while maintaining security, auditability, and performance.

The system 200 may comprise a functions module 204. The outer loop is fully conversational, whilst still fully delegating which questions can be answered to the question bank/inner loop. The outer loop only knows about the questions, not all of the underlying IRT/system functions. The functions module (part of the “inner loop”) may comprise and/or otherwise be associated with one or more REST APIs 206. The one or more REST APIs may be configured to provide one or more endpoints (e.g., 3 endpoints). For example, the one or more endpoints may be configured to one or more of: a) get all possible functions and metadata, b) invoke a specific function, and/or c) get metadata about the release of the IRT system including, for example, versioning data. For example, the function module 204 may comprise a backend service configured to expose a curated and version-controlled set of IRT functions via RESTful JSON endpoints. These functions may include operations such as retrieving drug request statuses, site data, or patient enrollment details. The functions module 204 may support GraphQL, allowing the LLM to request specific fields in a flexible schema. A function is a description to the LLM of ways that the present system can retrieve information on its behalf using RAG. A function and its parameters and results are described in detail to the LLM, and the LLM has been trained to ask for a function to be called and the information provided back to it. The present system calls the function, then passes the information back to the LLM so that the agentic dialog can continue. These functions may be referred to as low-level functions and/or plugins.

For example, the APIs may be configured to support introspection (e.g., metadata about each function (e.g., input/output schema, security role requirements) which can be retrieved dynamically.

For example, each function call may be subject to access control policies based on the user personas module (described below in greater detail). The user personas module may be configured to define one or more access rights of users based on roles such as clinician, sponsor, or blinded user. The function module consults these personas to enforce data visibility and function availability. The user personas may be expanded with contextual modifiers (e.g., trial phase, site geography) to further tune responses

The functions module 204 may be configured to expose one or more functions and/or one or more sets of functions released with the IRT. The functions module 204 may be configured to call one or more reports (e.g., one or more ad-hoc reports). The one or more reports may be stored at or otherwise associated with the authoring loop (described in greater detail below). The one or more reports may be based on metadata associated with one or more entities. The one or more reports may be presented as functions to the inner loop the authoring process. The one or more reports may comprise, for example, one or more SQL reports.

Providing the one or more reports negates the need for many specialized functions. The metadata associated with the reporting objects may be expanded to increase the coverage to encompass as much data as possible. The one or more entities may be marked-up and report entity roots may be added. The one or more entities (or “entity roots”) may be used in a unique constructions of reports by, for example, starting with a root like “patient” and then traversing a graph to another root such as “visits” and then on to another root such as “sites.” For example, a user may add in a new entity root of “depot” and then add in extra metadata so that reports around metadata could be constructed.” This is easier than adding new functions explicitly to query the data. For example, extending reports by doing development on the reporting subsystem can easily retire dozens of functions, as it's a more general system and thus easier to extend reporting than it is to develop additional functions. Allowing reports as functions increases the likelihood that the desired data can be extracted as part of answering a question.

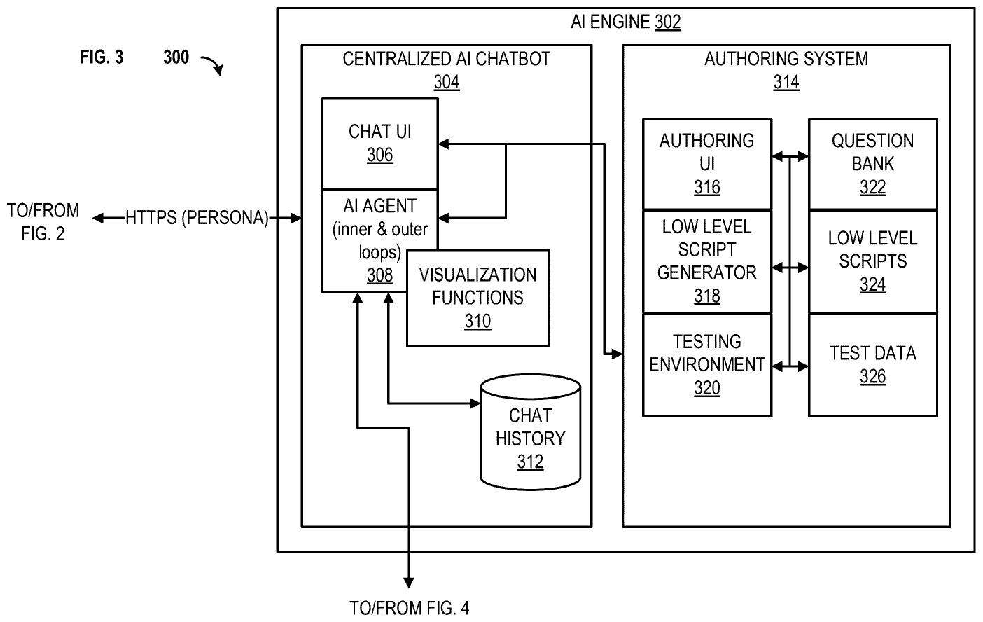

The functions module 204 may be in communication with a centralized AI chatbot 304 which may be part of an AI engine 302 (as described in greater detail with respect to FIG. 3). For example, the functions module 204 may be configured to communicate with (e.g., send data to and/or receive data from) the centralized AI chatbot (e.g., via the AI agent (inner loop and outer loop) 318, via HTTPs (e.g., incorporating the one or more personas)).

The system 200 may comprise a core IRT logic 208. The core IRT logic may be specific to a specific instance of an IRT and/or it may be universal, depending on the use case. It is to be understood that the core IRT logic 208 is the domain logic for the system and may be decoupled from the AI system. The functions module 204 may call into the core IRT logic 208 when needed. The core IRT logic 208 may be configured to allow the system to reliably and intelligently answer questions specific to the IRT domain, particularly questions that require access to trial-specific operational data such as drug shipment statuses, patient randomization, site inventory, etc. The core IRT logic 208 supports extensibility through the integration of ad hoc reports, which can be treated as callable functions, thus expanding the range of available data without requiring hard-coded changes to IRT. By centralizing this logic and including it within a validated, script-driven execution environment, the system ensures safe, scalable, and auditable interactions with IRT systems, ultimately supporting clinical operations through a highly structured and deterministic conversational interface. The ad hoc reports reduce the need to constantly upgrade the IRT module to expose new functions and new functionality. The reports can be created as part of the authoring process, essentially very flexible SQL-like queries, based on metadata around entities in the system.

The system 200 may comprise a drug management module 210. The drug management module 210 may be configured to expose specific endpoints from the IRT functions module 204 that allow the system to call for real-time data on drug availability, shipment statuses, depot capacity, patient assignment, and more. These functions may be defined with structured metadata, including their input parameters (e.g., request ID, site ID, date range) and expected output formats. During the authoring phase, subject matter experts may create rules for how to answer typical drug-related questions, and the LLM may convert and/or incorporate these into step-by-step scripts that call the relevant drug management functions in sequence. These scripts may be tested for accuracy against a live or sandboxed IRT instance and then saved in the centralized question bank. “Rules” may refer to business level instructions to the LLM that it uses to decide how to achieve a goal. An example might be a set of 6 steps to take when deciding why a drug request was not generated.

The drug management module 210 (like other components described herein) may be configured to operate within the constraints of the persona system, ensuring that only authorized users (e.g., unblinded supply managers) can access certain information.

The system 200 may comprise an IRT database 212. The IRT database 212 may define a structured relational or document-based store that holds persistent state for the IRT application. This includes trial-specific configurations, historical audit logs, and trial progress data.

FIG. 3 shows an example system (and/or subsystem) 300. The system 300 may in communication with (e.g., configured to send data to and/or receive data from) the system 200. For example, the system 300 may communicate with the system 200 to provide an intelligent agentic IRT experience. Agentic refers an AI agent. Agentic techniques involve presenting the LLM with a goal, and having it ask a set of questions and allowing it to invoke a set of RAG calls to get more information, and then finally presenting the answer. It relies on the reasoning ability of the LLM. An agentic loop might involve many to-and-fro dialog exchanges between our systems and the LLM before arriving at the final answer.

The system 300 (e.g., in particular the centralized AI chatbot 304) may make up part of the “outer loop” of the methods and systems described herein. For example, the centralized AI chatbot 302 may be user facing and configured to receive one or more user queries and/or prompts, send and receive information associated therewith, and output one or more answers. For example, the centralized AI chatbot 304 may comprise a chat user interface (UI or “chat UI”) module 306.

The system 300 may comprise an AI engine 302. The authoring system 314 is described in greater detail below. With respect to the inner loop and outer loop terminology, it is to be understood that these terms can refer to dynamic, real-time processes (e.g., a user interacting with the UI and the backend processes that execute to answer the questions) and also predetermined and/or preconfigured processes and data (e.g., the predefined questions, high level instructions, low level functions, and deterministic scripts). Thus, when the authoring system 314 is described as part of the inner loop, it is to be understood that the processes and data may be preconfigured, predetermined, and or predefined but may also be dynamically configured, determined, and/or defined.

Returning to the centralized AI chatbot 304, the chat UI may be configured to receive one or more user queries, one or more prompts, one or more commands, combinations thereof, and the like. The chat UI 304 may be a front-end user interface configured to receive one or more free-form natural language queries from end users, such as clinical trial managers, coordinators, or supply chain analysts. The UI 304 may be configured to support real-time, conversational interaction, rendering not only textual responses but also rich media visualizations when appropriate. The UI 304 may be configured to provide guided parameter input when required by the assistant (e.g., “What date was the request submitted?”) and translate complex back-end operations into a familiar, intuitive user experience. Through the UI, users can also review past queries, submit follow-up questions, and interact with compound outputs such as tables, charts, or audit logs.

The chat UI 306 may be coupled to (e.g., in communication with) an AI agent 308. The chat UI 306 can be considered an interface while the AI agent 308 is the intelligent backbone of the system and represents the intersection of the user facing outer loop and the back-end functionality of the inner loop. The outer loop functions as the high-level orchestrator, interpreting user intent and mapping it onto one or more pre-defined questions stored in a centralized question bank 322. Each question is modeled as a native LLM function with associated metadata, including required parameters and expected output types. The outer loop uses this metadata to clarify ambiguous queries, request missing parameters from the user, and dynamically remap the question if the user's intent shifts mid-conversation. Once the question and its inputs are fully resolved, control is passed to the inner loop.

The inner loop is responsible for executing the deterministic, low-level scripts associated with the selected question. These scripts are composed of structured steps that call into IRT (or other systems) via exposed functions or reports. The inner loop handles this execution in a tightly scoped environment, using only the minimal set of function metadata and truncated context history needed to avoid overloading the LLM context window. After execution, a separate validation call (potentially using a different LLM) confirms that the script was followed correctly and that the data was processed appropriately before the final answer is returned to the user via the outer loop. Typically, a conversation with an LLM, including all history, is sent to the LLM each time. The illusion of a dialog is created by sending a larger and larger full representation of the conversation each time and asking the LLM to add its answer to the end. The LLM can only handle a certain amount of tokens each time, and this is known as the context window. GPT4o has a context window of 128k tokens. This is large (approximately the size of a large novel) but it can fill up quickly with RAG information and history, leading to an error if we are not careful. The present systems and methods avoid this type of error where the context window is not large enough to complete solving an issue.

The AI agent 308 may be configured with (e.g., to cause execution of) one or more visualization functions 310. Thus, the AI agent 308 may be configured to present data-rich responses in ways that go beyond plain text. These visualizations might include depot inventory graphs, shipment timelines, or trial enrollment summaries, and can take the form of tables, charts, or even interactive components. Each visualization may be treated as a callable function within the system (in the same way or similar to any other data function) with defined input types and rendering logic. New visualizations can be centrally added to the system without requiring end-user software updates, allowing the assistant's expressive capabilities to evolve over time.

The centralized AI chatbot may comprise or otherwise be configured to communicate with a chat history database 312. The chat history database 312 may be configured to receive one or more chat histories and/or tokens associated with therewith and/or tokenizations thereof. For example, the chat history database 312 may be configured to capture and store a complete or partial trace of one or more user interactions, including user prompts, the LLM's outer loop responses and/or inner loop function executions, parameter clarification exchanges, function calls, script executions, and validation outcomes. This historical log may be immutable and auditable, forming part of the system's compliance architecture, especially within the regulated domain of clinical trials. It supports retrospective analysis, training data collection, issue triage, and regulatory audits. It also enables contextual continuity for multi-turn conversations, allowing users to refer back to prior answers or build on earlier queries without restarting the interaction. LLMs are configured to convert text into a sequence of numbers known as tokens. A token represents part of a word (e.g. “coll” from “collection”). A rough rule of thumb is that each word takes up approximately 2 tokens on average. Pricing and capacity of an LLM is measured in terms of tokens.

The AI engine 302 may comprise or otherwise be associated with or in communication with an authoring system 314. The authoring system 314 may be referred to as an authoring workbench. The authoring system 314 may incorporate an LLM (which may different from or the same as the inner loop LLM and/or the outer loop LLM (e.g., it may be a separate instance of the same LLM associated with the outer loop) to associate one or more predefined questions with one or more deterministic scripts (determined based on one or more high level instructions) comprising one or more low level functions configured to dictate how the system determines answers to user queries. This reasoning and logic can be checked and stored; and (2) when the user asks a specific IRT a question, the LLM asks clarifying questions to map onto one or more supported questions, then once this is done the system retrieves the lower-level instructions and executes them. Finally, the response is fact checked to ensure that correct information is presented to the user. Fact checking may refer to cross-checking the results of an agentic conversation, along with precise details of each RAG call, to separately check the results by using another LLM call.

The authoring system 314 supports the inner loop and may comprise an authoring UI 316. The authoring UI 316 may be configured to receive inputs from users (e.g., typically subject matter experts or “SMEs.”) For example, the authoring UI 316 allows SMEs to define, structure, and validate the business logic (e.g., the one or more high level instructions) that governs the system's question-answering behavior. Rather than writing code, users interact with the Authoring UI 316 using natural language inputs and guided workflows to generate and refine low-level deterministic scripts that the system will later execute in response to user queries.

The authoring UI 316 supports the creation and management of entries in the question bank 322, which is a curated repository of supported questions the system can answer. For each new question, the SME provides a natural-language description of the question and an explanation of the high-level rules (e.g., the high level instructions) or steps needed to determine the answer (e.g., “First check if the drug request was valid, then verify if there was available inventory at the assigned depot”). These rules form the basis for the AI-assisted script generation process.

Once the rules are entered, the authoring UI 316 invokes a large language model (LLM) to generate one or more deterministic scripts and/or one or more low level functions (e.g., a step-by-step plan that calls specific IRT functions or report-based virtual functions, in a deterministic sequence) via the low level script generator 318. The interface then allows the SME to review this script, test it in a sandboxed environment connected to a live or simulated IRT system, and confirm that it produces correct and expected outputs. If the script is not accurate or logically sound, the SME can refine the rules and re-generate the script until it meets the necessary quality and reliability standards. The scripts can also be validated by a separate instance (e.g., a validation instance) of the LLM.

The authoring UI 316 also supports metadata configuration, such as tagging questions with required parameters (e.g., site ID, request date), user role restrictions (e.g., blinded vs. unblinded access based on personas), and function dependencies. It includes tools to preview which IRT functions or ad hoc reports are available for use, and may allow filtering or selecting from subsets of functions to guide LLM reasoning within token constraints.

The authoring UI 316 may be integrated with a testing environment 320 and test data setup, enabling regression testing of new or modified questions before they are published for production use. This sandboxed testing capability ensures that changes can be validated without risking disruption to live clinical trial environments.

The low level script generator 318 may be configured to translate high-level business logic into one or more deterministic, executable sequences of function calls. It acts as an intermediary between the subject matter expert (SME) and the AI agent's execution environment, using a large language model (LLM) to generate structured, step-by-step instructions (e.g., deterministic scripts) that can be run against systems like IRT to answer predefined questions in a reliable and reproducible manner.

For example, an SME may enter a question (e.g., a predefined question which the system is configured to answer) into the authoring UI 316, along with an English-language description of the steps needed to answer it (e.g., the rules). These rules might include instructions such as “Check if the drug request was created,” “Validate the associated site,” or “Retrieve the current inventory for the relevant depot.” The low-level script generator takes these inputs and, with access to metadata describing available system functions (including their names, parameters, and expected outputs), prompts the LLM to construct the one or more deterministic scripts. When referring to a “deterministic” script, it is to be understood that the script is configured to outline what functions should be called and in what order, with particular inputs and associated conditional logic (e.g., if-then statements or the like).

Unlike traditional agentic LLM behavior, which reasons through each user query in real-time (risking hallucinations or inconsistency), the script generator locks in the reasoning process during the authoring phase. This allows the SME to inspect, debug, and correct the logic in advance, effectively validating the LLM's “chain of thought” before the script is ever executed in production. Hallucinations refer to the outputs of LLMs that are not based in fact. A chain of thought is when the LLM is asked to describe the steps it would take to solve a problem, either directly in a response or indirectly via a step-by-step generation of responses and further prompts. It is the LLM version of reasoning, and it is also subject to hallucinations. LLMs traditionally have no ground truth per se or set of axioms that ground their answers (despite the many amazing examples we have seen that imply human level intelligence). As such, there is no guarantee that the answers provided are correct. Incorrect information (often confidently delivered) is known as a hallucination. The present methods and systems may include a human in the loop to detect and correct hallucinations in generated scripts.

The script generator 318 may also be configured to respect token constraints (e.g., a consequence of context window limitations) by limiting the context window to only those function definitions relevant to the current question. The script generator 318 may be configured to allow SMEs to manually scope which functions are included in the prompt to the LLM, particularly as the number of available functions grows.

Once validated, the script is saved in the low level script database 324 and associated with one or more triggering question (e.g., one or more predefined questions stored in the question bank 322). When a user later asks a question during an outer loop live chat, the system determines an intent of the user's free-form natural language input, and, as part of the inner loop, determines an associated predefined question and associated deterministic script inner loop retrieves and executes the saved script directly. This preserves both the consistency and safety of the system, especially in high-stakes clinical trial settings.

The testing environment 320 may comprise a controlled, sandboxed framework designed to validate the correctness, reliability, and safety of low-level scripts before they are deployed into production. It is an essential component of the authoring workflow, ensuring that each question added to the system behaves as expected when executed against actual or simulated clinical data. For example, after a SME causes the creation of a new deterministic script via the authoring UI 316 and low level script generator 318, the script may be tested in the testing environment 320. The testing environment 320 may be in communication with a working IRT instance (e.g., either a test study environment or a replica configured with representative data) which allows real-time execution of scripts under realistic conditions. This means the script is not only checked for logical consistency but is also run against real system endpoints, such as functions that retrieve site data, patient records, depot inventories, or drug shipment statuses. Thus, the testing environment 320 allows SMEs to determine that correct functions are being called in the correct order, parameters are properly passed (e.g., study ID, request date, etc., . . . ), condition logic branches are functioning properly and are handled as intended, returned data matches expected returned data, and/or that errors are properly handled.

The testing environment 320 may support regression testing, allowing previously validated scripts to be re-run when IRT configurations change (e.g., when a new study is launched or an IRT upgrade occurs). This is critical in multi-tenant systems where each study may have slightly different field definitions, data availability, or high level instructions. By providing an isolated space for debugging and verification, the testing environment prevents the propagation of errors into the live conversational interface. It also enables compliance with regulatory and quality assurance standards, as every script can be shown to have been tested under controlled conditions before exposure to end users.

The authoring system 314 may comprise a question bank 322 configured to store one or more supported questions (e.g., predefined questions). Each question in the question bank may be presented to the outer-loop LLM as a native LLM function—with metadata describing the input parameters, and outputs. This means that mapping a user's intent to call a given question is handled by the LLM selecting which functions to call. This also handles chaining, where a set of functions must be invoked in sequence, and their responses combined, to answer a question.

These questions are the predefined questions developed by SMEs which the system can answer. When a user submits the one or more queries and/or one or more prompts, outer loop LLM processes the user input and determines the intent associated with the user input. The intent may be passed to the inner loop as a structured data object. Additionally/alternatively, the intent could be passed as a vector, and/or as a token string. By determining the intent and passing the intent as a structured data object, the system reduces token load during a conversation session. The one or more predefined questions in the question bank 322 may be canonical. The one or more predefined questions in the question bank 322 may be associated with one or more parameters (e.g., one or more pieces of information required to determine and output one or more answers to the one or more predefined questions) and/or one or more prompts configured to solicit additional information (e.g., missing parameters) from the user. The one or more predefined questions may be associated with role or persona restrictions, one or more expected output types, one or more pointers corresponding to one or more low level scripts, one or more optional links to fallback questions or related queries, combinations thereof, and the like.

The authoring system 314 may comprise a low level script database 324 configured to store one or more low level scripts (one or more deterministic scripts comprising one or more low level functions) generated by the low level script generator 318. The one or more low level scripts may be configured to explicitly outline one or more sequential steps (or sets of steps) which describe one or more functions to be called (and in what order) to answer a question (e.g., a predefined question and ultimately a user query). This translation of natural language high level instructions into a lower-level form uses the LLM's ability to create a step-by-step guide to solving the question—aka chain of though reasoning. Example high level instructions are shown below.

| | |
|---|---|
| 20 | In order to determine the reason why a drug request failed to generate a shipment, [symbol] |
| 21 | 1. The destination Site of the drug request must be active. |
| 22 | 2. The Drug Ordering must be Open at the destination Site. |
| 23 | 3. The drug ordering must be active at the source depot. |
| 24 | 4. The drug request status must be ‘Processed’ (3). |
| 25 | 5. There are not enough Intact drugs in the inventory of the source depot to fulfil [symbol] |
| 26 | 6. There must be enough intact drugs that are associated to a lot that is released [symbol] |
| 27 | When asked for the reason why a drug request failed to generate a shipment display [symbol] |
| 28 | If all the above checks are not failing, check if the drug request details has a Sh [symbol] |
| 29 | The user usually doesn't know the drug request id, so try to identify the drug requ [symbol] |
| [symbol] | [symbol] |

[symbol]

indicates data missing or illegible when filed

The low-level script associated with the above high level instructions may be: “to work out why a drug request on a specific date failed take the following actions:
1. Call {{call_depo_info}} and get the site id from the return structure
2. Call {{call_site_info}} using the site id
3 . . . ”

The system knows what functions to call based on metadata describing what each function does, and applying reasoning to know when to call which function. The business expert then checks that it has applied reasoning correctly. If the number of functions is too large (e.g., for a limited context window), the system can provide a grouping and a checkbox that allows the SME to select which function metadata should be considered. An expert or a separate instance of an LLM can check to make sure the reasoning has been applied correctly. An example of the checkbox functionality is shown below.

Functions to include:

| | | |
|---|---|---|
| [symbol] Site | □ Depot | □ Subject |
| □ Drugs | □ PCI | □ Notifications |

The authoring system 314 may comprise a test data database 326 configured to store test data. The test data may be set up in each of the IRT applications and may not be in the centralized system. Storing test data allows the system to be tested in a fixed manner, despite having a conversational, free form user interaction style. For example, the questions in the question bank 322 may be tested against the test data in the test data database 326. New instances of an IRT can be tested in the testing environment 320 using the test data 326. During the authoring workflow, when a new question is defined and a corresponding low-level script is generated by the LLM, that script is executed against one or more test data databases. This enables SMEs to observe function-by-function behavior (e.g., what inputs are being passed, what outputs are returned, and whether branching logic or conditionals behave as expected). The database supports multiple test configurations, including variations by study, by user persona, and even by IRT version. To maintain regulatory and clinical compliance, the test data can serve a compliance and quality control role. For example, validated scripts may be tested against this database, with outputs logged and version-controlled, creating a traceable record that a given script produced the correct result under defined conditions. Further, When an IRT instance is updated, or when new functions or reports are introduced, scripts can be retested against the test data database to verify continued validity, thereby enabling robust regression testing.

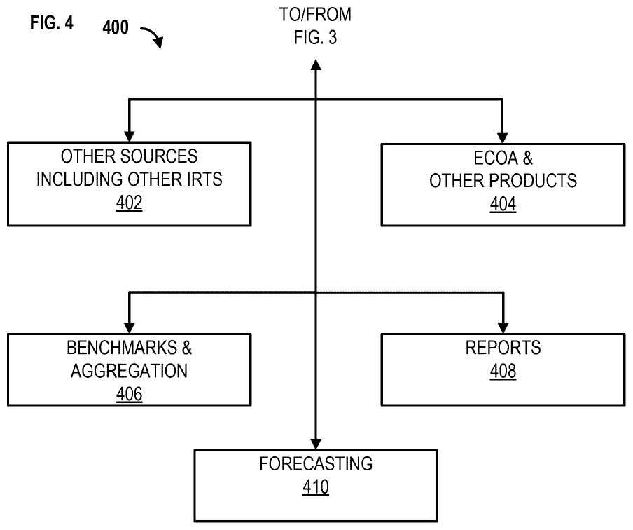

The centralized AI chatbot 304 (e.g., via the AI agent 308) may be in communication with one or more additional components (as described in greater detail with respect to FIG. 4.

FIG. 4 shows an example system (and/or subsystem) 400. The system and method 400 may comprise other sources (including other IRTs) 402, ECOA & other products 404, benchmarks and aggregation 406, reports 408, and forecasting 410. The system 400 may be in communication (e.g., send data to and/or receive data from) the system 300. For example, the components of system 400 may be configured to communicate with the AI agent 308 of FIG. 3. For example, the systems described herein may be configured to interact with more than one instance of an IRT and thereby aggregate data and/or functions from multiple IRTs (across different studies, sponsors, or deployments) and even from other third-party systems. This may include historical trial data, trial configuration metadata, or performance statistics exposed through additional function endpoints or integrated reporting systems.

System node 404 (ECOA and other products) may comprise one or more electronic clinical outcome assessments (eCOAs), one or more payment systems, one or more monitoring tools, one or more regulatory dashboards, combinations thereof, and the like. By pulling data from these adjacent systems, the present systems and methods can contextualize IRT data with broader operational signals (e.g., such as patient-reported outcomes, visit compliance, or payment delays).

The system node 406 (Benchmarks and Aggregation) may be configured to serve as a logic for cross-study or cross-system comparisons. The benchmark and aggregation node 406 may be configured to aggregates structured outputs (e.g., such as shipment times, depot stock levels, protocol deviation frequencies, or user query patterns) and allows those to be benchmarked against historical or peer trial data. For example, the benchmark and aggregation node 406 may be invoked to answer questions such as, “How does depot inventory depletion rate in Study A compare to similar oncology trials?” or “Which sites across studies consistently fall below median supply thresholds?”

The system node 408 (reports) may be configured to store, send, receive, or otherwise process one or more reports. The one or more reports may be ad hoc reports, preconfigured reports, configurable data queries, combinations thereof, and the like.

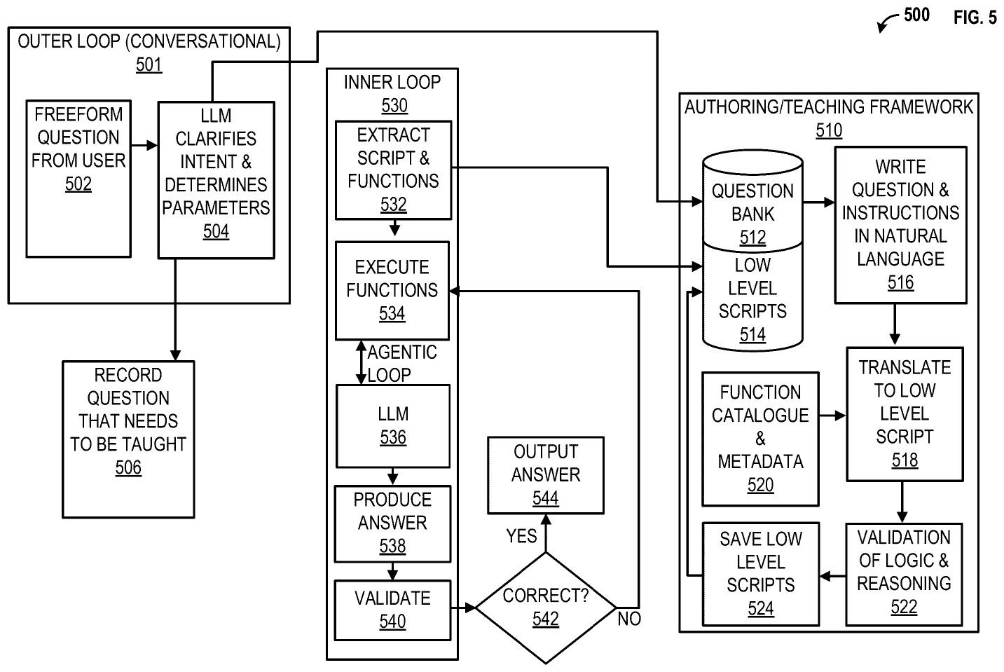

FIG. 5 shows an example system and method 500. The example system and method 500 may comprise an interaction between the outer loop (which determines which question is being asked), the inner loop (which executes the script for the chosen question) and the authoring framework which creates the script from English-level instructions, also allowing it to be checked by an expert user. The example system 500 may comprise a conversational outer loop 501, an inner loop 530, and an authoring/teaching framework 510. The conversational outer loop 501 may be configured to receive one or more user queries or prompts and output one or more answers to the one or more user queries or prompts. The inner loop 530 may be configured to determine the one or more answers to the one or more user queries or prompts (e.g., deep answers) and cause the outer loop to output the one or more answers. The authoring/teaching framework 510 may be configured to facilitate human in the loop SME supervision of the system 500.

The conversational outer loop 501 may, via a conversational interface such as a chatbot, receive one or more free form questions, queries, prompts, etc. from a user (e.g., at 502). The outer loop is the conversational assistant that the user interacts with. The conversational outer loop may comprise an LLM agent, which determines which underlying inner loop question the user is asking, clarifies parameters, and then passes control to the inner loop which executes the previously saved script to answer the question. The LLM associated with the outer loop (as well as the other LLMs incorporated into the present methods and systems) may be configured for multilingual support. For example, the outer loop LLM and/or the inner loop LLM and/or the authoring LLM may be configured for language detection and translation. For example, the one or more LLMs may be configured to receive an input in a first language and translate the input to a second language. As described in greater detail below, the one or more high level instructions, one or more predefined questions, and/or one or more scripts may be written in a canonical language. Thus, in order to correctly match (e.g., determine an associated between) the one or more user queries received via the conversational outer loop to the one or more predefined questions associated with the question bank in the inner loop, the one or more user queries may be translated from the language in which they are received to the canonical language of the one or more predefined questions.

For example, a user may initiate interaction with the system by entering a natural language query within the IRT environment (e.g., “Why didn't my drug shipment generate?”). This query may be vague, under-specified, or phrased in site-specific terminology. At 504, the LLM may determine (e.g., clarify) the intent of the user input. For example, the system may utilize an outer loop large language model (LLM) to interpret the user's input, determine intents associated therewith, and if necessary generate clarifying prompts. This forms an agentic loop that iteratively refines the user's intent, possibly involving multiple back-and-forth exchanges. For example, if a user enters “Why don't I see my drug request?” the system may match the user input to a predefined question such as “Why did my drug request fail to generate?” This predefined question may require certain additional information such as “request date,” and/or “request ID.” Thus, the outer loop may prompt the user to provide the request date and/or request ID. If the user cannot provide this information, the system may determine an alternative (but similar) predefined question that does not require the request date or request ID. For example, the system may determine the predefined question, “Show the status of my drug requests over the last N days.”

Once intent is clarified, the intent may be used to select the appropriate question from the question bank 322). When the inner loop has the correct intent and/or parameters, the inner loop LLM may retrieve a corresponding low level script and executes the steps by sending in a prompt to the LLM with only the function metadata corresponding to the functions referenced in the low-level script. The inner loop contains a set of predefined questions (aka the question bank) which the assistant can answer. The inner loop is supported by an authoring workbench, which allows an expert to write detailed business-level English instructions, which are then translated by the LLM into a script which describes which low level product “functions” will be invoked and the logic needed to answer the question. The script for each question is checked by the expert as part of the authoring process and saved for later recall in order to be more deterministic.

The authoring/teaching subsystem 510 produces the question bank (an questions therein), which is then used by the inner loop (e.g., in that questions and other data are associated with the authoring/teaching subsystem and may queried or otherwise determined by other system components).

Based on the intent of the user input, one or more predefined questions and one or more low level scripts associated therewith are determined. Once the appropriate predefined question is determined, the outer loop LLM may call the inner loop to initiate the backend process for the chosen question. For example, the inner loop 530 may, via module 532 extract the one or more low level scripts (and constituent functions).

In the case that the system cannot determine an appropriate predefined question that corresponds to the user's query, at 506, the user's query may be recorded so that a predefined question and associated low level script and functions can be authored.

After the appropriate deterministic scripts and functions are determined, the inner loop 530 may, at 534, execute the one or more functions. For example, after the user's intent is determined and/or clarified, the system selects a known question, and the inner loop retrieves the corresponding deterministic script comprising one or more functions. The deterministic script outlines exactly which functions the system should call and in what order, and with what other additional inputs or parameters. The system then begins executing the steps in the script. At each step, it may invoke a function exposed by a backend system (e.g., an IRT function or report), supplying parameters that were previously clarified in the outer loop. These functions return structured data (e.g., a JSON object with inventory levels or shipment status).

Executing the script and calling functions may implicate (or give rise to) an “agentic loop” with an inner loop LLM 536. For example, as data is returned, the inner loop LLM 536 may assist in interpreting intermediate results, combining outputs, or conditionally branching based on script logic (e.g., “if inventory is 0, skip shipment check”). However, it does so only within the guardrails of the script, not by improvising logic on its own.

Once all the steps in the deterministic script have been executed (e.g., all the functions have been called), the system produces one or more answers at 538. Producing the one or more answers may comprise assembling one or more pieces of data and/or converting structured data objects to one or more natural language responses. The one or more natural language responses (like the one or more natural language user queries) may be in any language and may be translated from a first language to a second language if appropriate.

At 540, the one or more answers may be validated. Validating the one or more answer may comprise invoking a separate LLM to inspect the execution trace (e.g., by comparing the original script, the function calls made, and the data returned) to determine that the script was followed correctly and/or that the one or more answers make sense. If validation fails at 542, (e.g., due to missing data, inconsistent output, or a logic misstep), the method may loop back to 532 to re-extract and/or re-determine one or more scripts and/or one or more functions and/or to 534 to re-execute previously executed functions and/or execute one or more additional and/or alternative functions. If the validation succeeds, at 544, the one or more answers may be output (e.g., returned to the outer loop for output via the conversational interface). The one or more answers may be output to the user in the same language as (or, if desired, a different language from) the one or more user queries. For example, the one or more answers to the one or more predefined questions may be determined in the canonical language and translated from the canonical language to the language preferred by the outer loop user.

Returning to the authoring/teaching subsystem 510, and as previously mentioned, the authoring/teaching subsystem 510 may comprise the question bank 512 and a low level script database 514 storing one or more low level scripts associated with the one or more predefined questions in question bank 512. The one or more predefined questions may be authored by one or more SMEs, and the one or more low level scripts comprising one or more functions may also be authored by the one or more SMEs. For example, at 516, the one or more natural language questions and one or more natural language instructions may be authored. For example, the SME may enter a question, forming part of the question bank: “Why did my drug request fail to generate a shipment?” along with instructions like “Find out which request on which date, and what is the request id.” The SME may also enter high level instructions (as described above). An LLM may be invoked as part of the authoring process by entering a specific prompt configured to convert the rules to one or more deterministic scripts comprising one or more functions (e.g., via a translation module 518).

The translation module 518 may translate the one or more natural questions and one or more natural language instructions may be translated to one or more low level scripts. To translate the one or more natural language questions and the one or more natural language instructions to one or more low level scripts, the module 518 may pull data from a function catalogue configured to store one or more low level functions and associated metadata (520).

At 522, the logic and reasoning associated with the one or more deterministic scripts may be validated. The validation and reasoning may be checked by a separate LLM configured to determine the deterministic script is configured to achieve the result intended by the one or more natural language questions and/or one more natural language instructions authored by the SME. Once the logic and reasoning of the deterministic scripts are validated, they may be saved at 524 in the question database 512 and/or the low level script database 514. After a bank of questions is created, the bank of questions can be checked against a test IRT instance. SMEs can write test scripts to validate the output. In addition, when implementing a new IRT instance for a study, test scripts can re-run to check that instance for correctness

The outer loop/inner loop architecture and process flow shown in FIG. 5 has several important features. For example, the separation of inner-loop script authoring and execution makes the system more reliable by greatly reducing the chance of hallucinations and ensuring that an expert can check any chain of thought (aka reasoning) produced by the LLM. This is done ahead of time for each supported question from the pre-defined question bank, allowing users to know that when asked the question that the LLM will follow a tested script. The architecture also means the system is testable in that it may be tested along known question vectors (e.g., known question variants) using a fixed set of input vectors. For example, the authoring flow that the Centralized Authoring System is connected to a working IRT (and other systems) so the expert user can debug and save the reasoning that the LLM comes up with and validate results to check the logic. Further, this approach allows supported questions and RAG functions to scale to large levels without going over any of the LLM context window limits. Additionally, the system architecture provides for centralization of the logic in a combination of multi-tenant and single-tenant systems, so the system can be taught and the intelligence of the system can be expanded. RAG refers to a technique where the LLM can ask for more information by requesting that a system do a query on its behalf and provide it with the data in a subsequent call. The RAG is scope limited such that a given environment controls queries and what data the LLM sees.

The present methods and systems address chain of thought/reasoning problems by using a question bank and directing the user to a pre-defined and pre-tested questions—each of which have already been broken down into a script: atomic actions and function invocations in the authoring phase rather than in the conversational phase. This allows the domain expert to check that the chain of thought has been broken down into the correct functions using the correct logic.

The present methods and systems address hallucinations by restricting free form questions and determining a predefined question associated with free form questions wherein the predefined question is already associated with a deterministic script. The deterministic scripts and their execution may be validated using another LLM call before the answer is output to a user.

The present methods and systems can handle mathematical calculations (which traditional LLMs are notoriously bad at) by incorporating a calculator plug-in.

The system offers a robust, enterprise-grade conversational AI platform designed specifically for complex, regulated environments like clinical trial operations. Its architecture is built for reliability and accuracy, ensuring users receive consistent, deterministic responses based on pre-validated logic rather than open-ended LLM reasoning. Unlike traditional chatbots, the present system is fully testable and auditable, with each supported question linked to a deterministic script that can be evaluated in advance using a sandboxed environment. This enables rigorous validation, even though the user interface remains fully conversational and flexible. The system also prioritizes safety and access control, enforcing role-based permissions to prevent unblinding or data leakage, and logging every interaction and reasoning step for regulatory compliance and retrospective analysis.

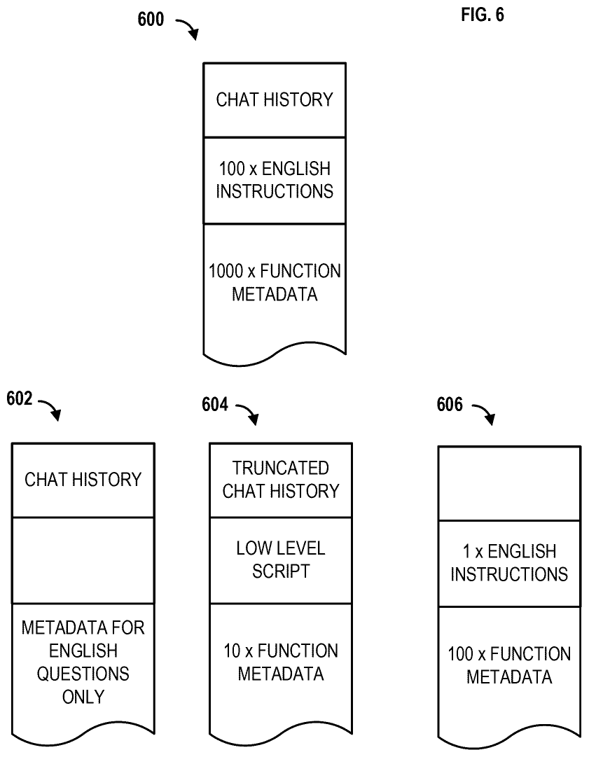

FIG. 6 shows example context windows, tokens and/or tokenization. Context window 600 reflects a naïve RAG agent approach which would provide all of the business-level instructions to answer each question in the context window for each LLM interaction, and provide all of the metadata for every available functions. Context window 600 comprises chat history, tokens for English instructions, and tokens for function metadata. For purposes of illustration, with respect to context window 600, assume that there are 100 questions, with associated 100 English language instructions and each instruction takes 500 tokens, and that there are 1000 total functions each taking 200 tokens. In this case the instructions and function metadata will use up 100*500+1000*200=250 k tokens. This is too large for the 128 k token window of GPT models, let alone any chat history required.

However, as shown by context 602, which shows a context window for the outer loop, the system may only need the metadata for the 100 English language questions. Context window 602 comprises tokens for chat history and tokens for metadata for English questions. This metadata is required to describe each question as an LLM function—if each question/function requires 200 tokens (which is relatively normal), then the context window 602 only consumes 20,000 tokens, which leaves 108,000 tokens available for other purposes (e.g., for sending chat history).

Context window 604 shows the context window for the inner loop. Context window 604 comprises tokens for a truncated chat history, tokens for low level scripts, and tokens for function metadata. For purposes of discussion, consider the system is answering a single question. Assume that the low-level script takes up 500 tokens, and that the question invokes 10 functions each requiring 200 tokens. This means the inner loop context window (e.g., token window) consumes 2,500 tokens, leaving 125,500 tokens for a chat history.

Context window 606 shows a context window for the authoring of a single questions. Context window 606 comprises tokens for English instructions, and tokens for function metadata. For purposes of discussion of context window 606, the tokens for an English language business instruction may be 500 tokens. Thus, by having the domain expert select which function categories are used, the present systems and methods narrow the functions used from 1000 down to 100. In this case, the authoring loop token window consumes 20.5 k tokens, and this is a sunk cost per question in the authoring process and so it is not included in the conversational token calculations.

Comparing a naïve RAG agent to the present methods and systems, the naïve RAG agent may require 250,000 tokens per LLM answer which might not fit in the 128,000 token context window common in industry. The present systems and methods, by virtue of separating the outer loop, the inner loop, and the authoring loop, can reduce the cost (in tokens, e.g., to around 22,500 tokens per LLM answer) which leaves more room in the context window for chat history. Thus, not only are the present systems and methods are more scalable by more than a factor of ten, but also the smaller number of tokens for each LLM interaction means that it is faster and cheaper than a naïve RAG agent approach. The above 3-tier breakdown can comfortably handle 3-4 times the number of questions shown above, whilst still retaining enough context window to handle any possible chat length.

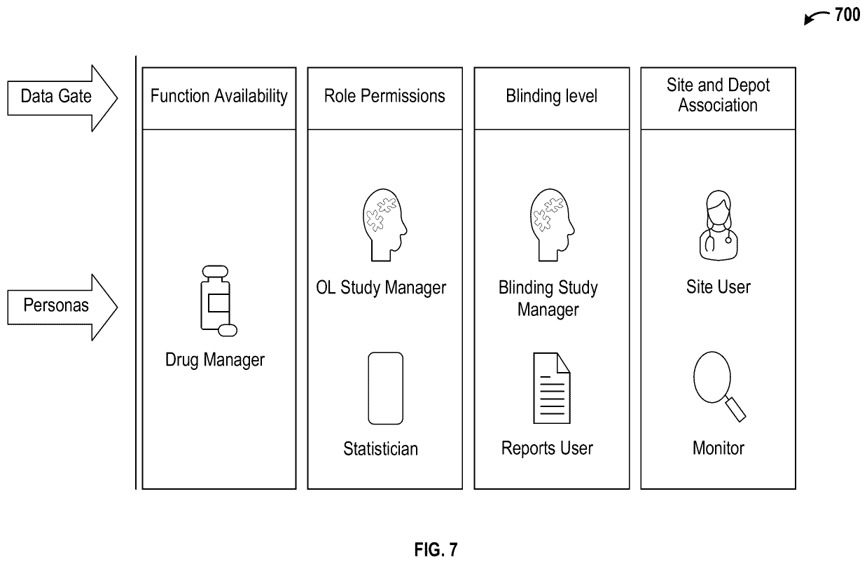

FIG. 7 shows example persona gated process flows. For example, the present systems and methods may incorporate one or more personas. The one or more personas may be associated with one or more settings and/or designations. For example, the one or more personas may be blinded or unblinded. The various functions are aware of these personas, and the functions and personas may be tested to ensure the system only outputs information suitable for the persona of the user. The functions available for a given IRT can be directly interrogated. This can be matched up with the low-level scripts to see which ones can be run, which can be directly translated into filtering of the high-level questions. In other words, AskIRT should be able to answer the question of “What questions can I answer?” and “What questions exist that my IRT or my persona cannot ask?”

This feature creates a “self-awareness,” in circumstances where the system may be interrogated by a user. For example, answering questions like “What questions can you answer related to sites?” Because each question has been turned into a function, the system can handle this by instructing the LLM to summarize what functions are available in the outer loop.

The persona labeled “Drug Manager” is shown as having access to core pharmaceutical logistics functions. These may include execution of API calls to retrieve depot shipment data, initiate or halt drug resupply orders, and invoke inventory tracking routines. The system may be configured to expose only medication-related functions to this persona, using annotations in the function metadata to restrict access dynamically at runtime. For example, the drug manager persona may be granted access to get_depot_inventory( ), release_drug_shipment( ), and query_label_batch( ) functions, while the statistician may be restricted to functions like summarize_subject_dropout( ) or aggregate_dose_response( ) and denied access to subject-level inventory or shipment controls.

The drug manager persona is merely exemplary and explanatory and is not limiting. A person skilled in the art will understand the model may be configured to execute based on any persona. The role permissions gate may be configured to determine one or more role permissions associated with the one or more personas. The role permissions gate 520 may be configured to provide finer-grained authorization based on functional job titles or study-specific responsibilities, often within the same blinding class. Unlike function availability, which filters based on broad persona categories, this gate discriminates between sub-roles within shared personas. For example, both the Open Label (OL) study manager and statistician may be assigned a broader “Study Team” persona. However, their roles may have distinct permissions sets. The one or more role-based permissions may be stored as access control lists (ACLs) or role-policy mappings within the centralized authoring system 410 or a policy engine integrated with the function module 204. Each function or low-level script may include a required role tag (e.g., minRole=study_manager), and requests from lower-tier roles may be rejected or redirected with an appropriate fallback response.

For example, the OL Study Manager may be configured for access to functions involving subject-level data, including randomization assignments, treatment arms, and visit-specific drug administration logs. For example, the Statistician persona may be more restricted, with access typically limited to de-identified and aggregate datasets. This role may be barred from functions exposing identifiable treatment assignments, in compliance with role-based access control protocols configured in the function module 204.

The blinding level gate may be configured to enforce study blinding protocols by filtering access to data fields or functions that would compromise treatment concealment. Personas such as Blinded Study Manager or Reports User may be restricted from accessing any API or script that references treatment arm, investigational product identity, dose group, or unblinded inventory location. For example, the blinding level gate 530 may be configured to operate across both data content and function metadata layers. For example, at the function layer each callable function may be annotated with a requiresUnblindedAccess=true flag. Any such function is automatically excluded from execution or visibility for blinded users. Similarly, at the data layer, query results may be redacted, masked, or tokenized when returned to users under a blinded persona. For example, drug names may be returned as Drug A, Drug B, or Masked, depending on the user's access level. The blinding level gate may be enforced during clarification exchanges in the LLM's agentic dialog loop, blocking the model from even requesting parameters (e.g., “what treatment did the subject receive?”) that would violate blinding.

The site and depot association gate may be configured to apply contextual filtering based on geographic or institutional affiliation, ensuring that users only access information for locations they are authorized to manage or observe. For example, a site user persona may only view or interact with subjects, shipments, and visit records associated with their own site ID(s). These restrictions may be embedded directly into low-level scripts through dynamic parameter binding (e.g., where site_id=:user_site_id. Similarly, a monitor persona may be granted read-only access to a subset of sites or depots, and their access may be further scoped to specific visit windows, query types, or audit events. Function calls for monitors may be internally converted to SELECT-only queries with locked parameters and logging enabled.

The site and depot association may be enforced by appending site/depot scope constraints to backend API requests or by intercepting user prompts and removing prohibited references. In multi-site trials, this filtering prevents cross-site data leakage and supports regulatory audit trails by associating all access with specific location-based credentials.

For example, prohibited references may comprise natural language inputs that, if processed by the system, could result in unauthorized disclosure of sensitive, blinded, or out-of-scope information based on the user's assigned persona. Within the system (e.g., the system 200, 300, or 400), such references are particularly relevant to enforcement of the blinding level gate and site/depot gating logic. For example, in blinded studies, prohibited references may include direct or indirect requests for treatment allocation, such as “What treatment did subject 1023 receive?” or “Compare the efficacy of Arm A versus Arm B.” These queries attempt to access unblinded data that the user's persona is not authorized to view. Similarly, references like “List all subjects on Drug X” or “Show the depot location for the placebo group” are considered violations of blinding, as they expose sensitive protocol information.

In the context of site and depot access controls, prohibited references might include queries that attempt to access data for sites or depots outside the user's authorized scope. For instance, a user associated with Site 105 may not be permitted to execute queries like “Show drug inventory at Site 201” or “Download visit history for subjects at Depot D003.” Thus, these controls ensure geographic and organizational data segmentation is maintained in multi-site clinical trials.

Prohibited references can also relate to role-inappropriate actions, such as when a lower-tier user attempts to invoke privileged administrative functions. Queries like “Cancel a drug shipment,” “Override randomization for subject 1030,” or “Trigger emergency unblinding” might fall into this category. Although these are legitimate backend functions, they are reserved for higher-privilege roles such as Study Administrators or Logistics Managers and are therefore inaccessible to Site Users or Monitors.

To mitigate risks associated with prohibited references, the system may be configured to detect and filter these inputs before LLM processing, either by blocking them outright, prompting the user to rephrase, or redacting sensitive outputs. Attempts to access prohibited content may also be logged for audit purposes and reviewed by compliance officers to ensure regulatory integrity.

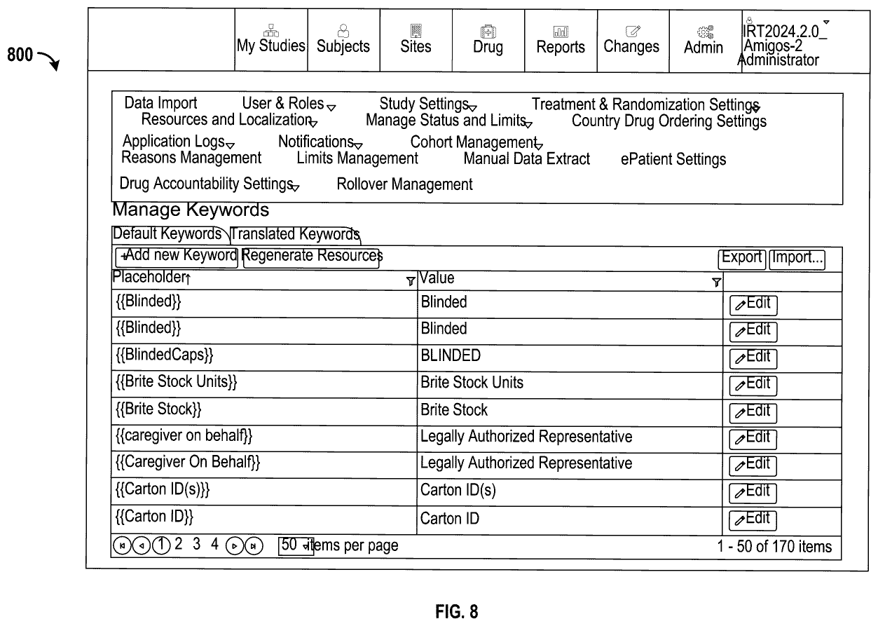

FIG. 8 shows an example interface 800. The example interface 800 shown is a “Manage Keywords” interface. This is merely exemplary and explanatory and is not limiting. The interface 800 may be configured to provide a centralized, administrator-accessible tool that is configured for defining, editing, and synchronizing keyword placeholder mappings used throughout an IRT system for terminology normalization and localization. This interface enables non-developer users—such as study administrators or configuration specialists—to manage the symbolic keywords that are substituted into or out of system interactions and outputs.

For example, the interface 800 may be configured to canonical-to-localized term mapping, thereby allowing administrators to associate canonical placeholders (e.g., {caregiver.on.behalf}) with trial-specific terminology (e.g., “legally authorized representative”). This is critical for studies that use different terms for the same concept, depending on sponsor preference, regulatory jurisdiction, or language. The interface 800 may be configured to standardize LLM inputs and outputs. For example, by managing consistent placeholder tokens across a trial, the system ensures that natural language queries are internally aligned with a centralized question bank. It also enables LLM responses to be rendered using trial-specific vocabulary without retraining or rewriting core logic.

Further, the interface 800 may be configured for support of localization and translation. For example, the interface 800 may support a multi-tab structure (e.g., “Default Keywords” vs. “Translated Keywords”) to allow language-specific overrides. This is particularly useful for multinational studies, where the same placeholder may need to render different values in different locales (e.g., “legally authorized representative” in English vs. “représentant légal” in French). Similarly, some IRTs suse “legally authorized representative” and others use “caregiver on behalf” Regardless of language or terminology, and the present systems and methods can be configured to maintain questions in the question bank in canonical language (e.g. the placeholder names) and translate the question from the local terminology into canonical form to match with the questions in the predefined question bank. The predefined questions in the question bank in the canonical language can be translated back to local language or terminology where appropriated. For example, keywords can be added that map to any prompt. The one or more user queries may be translated to the canonical language for improved matching to the one or more predefined questions.

The interface 800 may also provide dynamic UI and document rendering. For example, the interface 800 may allow users to manage keywords used in dynamically generated reports, web interfaces, subject communications, and alert messages. Updating a keyword in this interface ensures consistent terminology use across all user-facing system components.

The interface 800 may support configuration portability and version control. For example, the interface 800 may support import/export operations, which facilitate cloning configurations across trials or study phases. It also enables version-aware change control when terminology is revised during a protocol amendment or system upgrade.

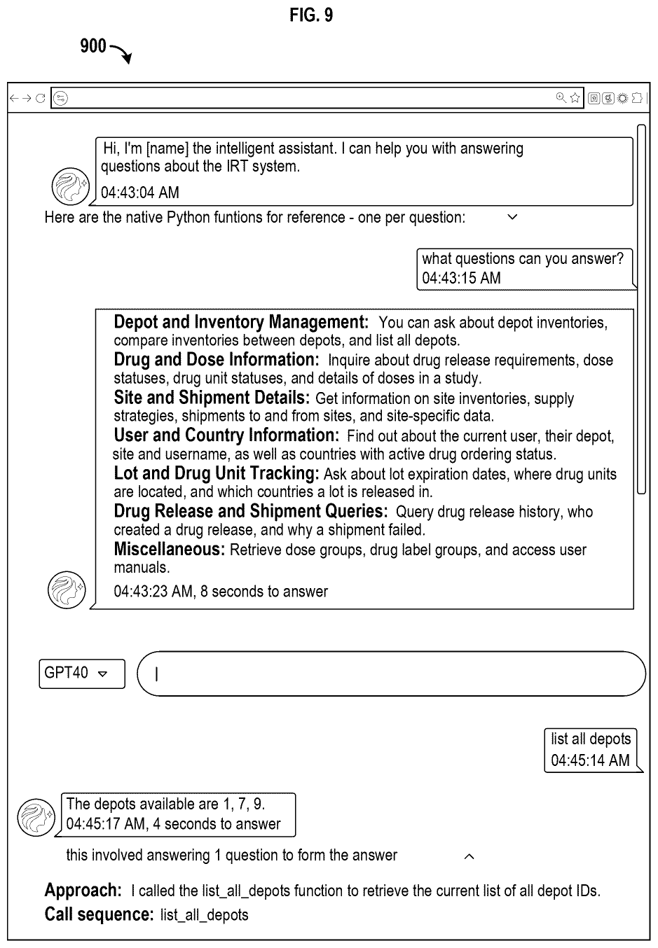

FIG. 9 shows an example user interface 900 of the outer loop experience. In FIG. 9, the user has prompted the system to answer “what questions can you answer?” In response, the system may present a list of subjects about which the user can ask, and about which the system is configured to determine and present information. For example, if the user (as in FIG. 9) asks the system “what questions can you answer?” the system may output an answer summarizing all the functions the systems can call.

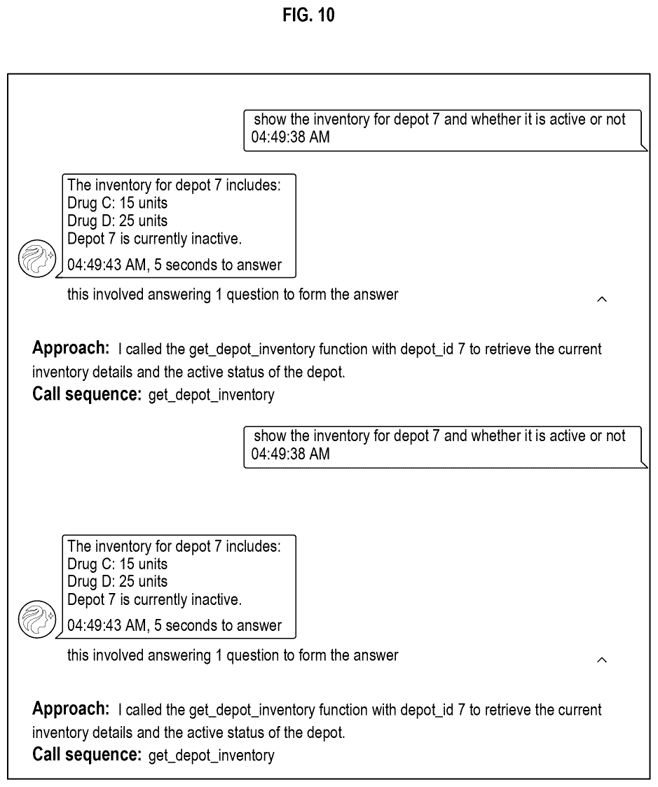

FIGS. 10A-10C show examples of the outer loop experience. For example, FIG. 10A shows receipt of a user prompt “list all depots.” The present methods and systems may cause an output of an answer determined according to the methods and via the system described herein. For example, in FIG. 10A, the conversational outer loop LLM may respond with “The depots available are 1, 7, 9.” As shown in FIG. 10A, answering that question (e.g., responding to the prompt) involved answering 1 question to form the answer. Answering the question comprised calling a “list_all_depots” function according to the call sequence “list_all_depots.”

Similarly, as shown in FIG. 10B, the present systems and methods, as an example, may be configured to list inventor for a single depot. For example, the user prompt may comprise a natural language statement, “show the inventor for depot 7 and whether it is active or not.” This prompt is slightly more complex than the prompt in FIG. 10A (“list all depots.”) However, by answering a different question, specifically calling the “get_depot_inventory” function with “depot id 7,” the system may retrieve current inventory details and a status (e.g., active or inactive) of a given depot. As shown in exemplary FIG. 10B, the system may output an answer such as, “The inventory for depot 7 includes: Dug C: 15 units, Drug D: 25 units, Depot 7 is currently inactive.”

As shown in exemplary FIG. 10C, the system may be configured to answer four questions to form an answer. For example, in FIG. 10C, the prompt is “list the active inventory for all depots.” The system determines one question needs to be answered, and determines that answering the one question will require calling one or more functions according to an associated deterministic script. After determining, based on the user prompt, the one or more preconfigured questions, associated high level instructions, and deterministic scripts comprising one or more low level functions, the system calls “list_all_depots,” and in parallel, “get_depot_inventory” for each depot to retrieve inventory and active status. Depot 7, due to an inactive status, was excluded. The sequence shows how each inner loop question is presented to the outer loop as a native LLM function (e.g. “What depots are there?” translates into the function call list_all_depots). The sequence shows that if a more complex question is asked, the LLM will attempt to break it down into a set of atomic questions/functions—e.g. list_all_depots, then get_depot_inventory. In this case, the outer loop conversational assistant only has access to the functions corresponding to each question, while the inner loop LLM has access to the low level functions for communicating with IRT etc. A validation may performed by a separate LLM (which may be a distinct instance of the same LLM used in the outer loop or the inner loop), that looks at the intermediate LLM chat history and determines if it aligns with the separate inner-loop scripts.

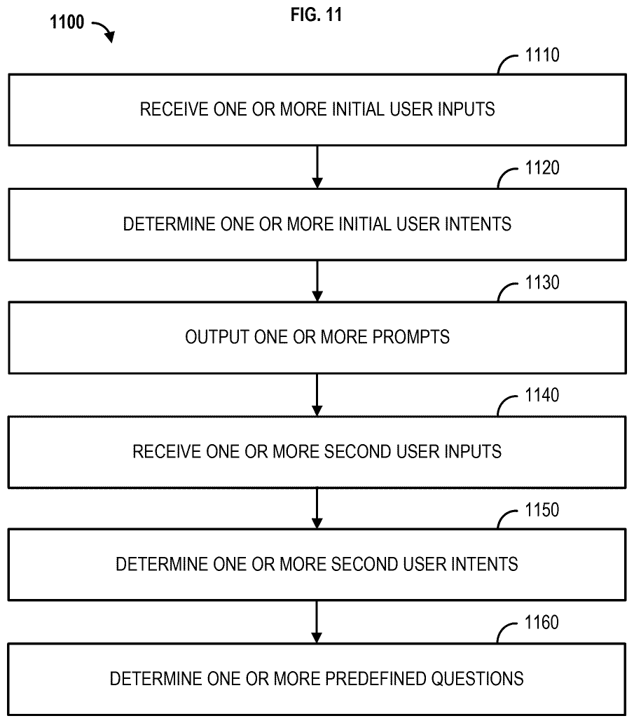

FIG. 11 shows an example method 1100. The method 1100 may be carried out via any one or more of the devices described herein and may incorporate an interactive response technology (IRT) system. The interactive response technology system may comprise a test harness and wherein the test harness comprises an automated environment that runs the question bank against a sandbox instance of the conversational virtual assistant, and wherein the test harness is configured to use one or more validation checks to determine the one or more user queries were answered correctly. At 1110, one or more initial user inputs may be received. The one or more initial user inputs may be received via a conversational outer loop. As part of the outer loop process, a user may interact with a conversational assistant powered by an LLM agent. For example, the user may, for example, via text or voice input, input a query such as “Why don't I see my drug request?” For example, the LLM may be configured to receive the one or more user inputs via a conversational interface, an application programming interface (API), a graphical user interface (GUI), a text-based input field, or any combination thereof. The one or more user inputs may comprise natural language text, speech-to-text output, structured queries, commands, or other input signals representative of user interaction. Upon receiving the one or more user inputs, the LLM may be configured to perform one or more preprocessing operations, which may include tokenization, embedding generation, syntactic parsing, semantic analysis, contextual vectorization, and/or normalization of the input(s) to generate one or more internal representations of the received user inputs.

Also at 1110, one or more initial user input parameters may be received and/or otherwise determined. For example, the one or more initial user input parameters may comprise identifying information in the one or more initial user inputs. For example, the one or more parameters may comprise a request ID, a site ID, a date, a date range, a product lot, other identifiers, combinations thereof, and the like.

For example, the conversational interface may comprise a virtual assistant, chatbot, or the like. For example, the conversational interface may comprise or otherwise be associated with an interactive response technology system, an intelligent virtual agent, a large language model (LLM), combinations thereof, and the like. The LLM may be associated with a conversational outer loop. For example, the conversational interface may comprise a web-based UI, mobile app, or embedded chat widget. For example, the one or more user queries may comprise one or more free-form natural language utterance submitted by a human user such as a clinical trial site coordinator, supply manager, or patient care representative. The conversational interface may be configured to send the one or more user queries as a prompt to a backend LLM system (e.g., GPT-4o) for processing.

The conversational interface may be configured to support voice input, text input, and/or voice-to-text conversion. The conversational interface may comprise or otherwise be associated with a pre-processor configured to pre-process the one or more user queries. Pre-processing may comprise lowercasing the input, removing stopwords, lemmatizing tokens, and analyzing part-of-speech tags to form a grammatical structure of the sentence. Named entity recognition may also be applied to identify key terms such as product names, dates, user types, or order references. A token or tokenization refers to the LLM translating text into a sequence of numbers known as tokens. A token represents part of a word (e.g. “coll” from “collection”).

At 1120, one or more initial user intents may be determined. For example, based on the one or more internal representations, the LLM may be configured to determine one or more user intents. Determining the one or more user intents may comprise classifying the one or more internal representations into one or more predefined intent categories using a neural network classifier, intent recognition model, or probabilistic inference engine. In some embodiments, the LLM may compare the internal representation(s) to a set of predefined exemplars or prompt templates corresponding to supported intents. In other embodiments, determining the one or more user intents may comprise identifying latent intent embeddings in a high-dimensional space using similarity metrics (e.g., cosine similarity or Euclidean distance) to known labeled examples. The one or more user intents may indicate, for example, a desired information retrieval action, a request for task execution, a clarification request, a follow-up inquiry, or a domain-specific operation, and may serve as a basis for subsequent function selection, response generation, or downstream processing.

Determining the one or more user intents may comprise matching (based on the intent) the one or more user inputs to one or more predefined questions in a question bank. The one or more user intents may be determined by the outer loop LLM. The one or more predefined questions may be stored in (e.g., aggregated in) a question bank. For example, the outer loop may be configured to interpret user inputs (e.g., the one or more user queries) and map them to one or more “questions” in a curated question bank. For example, each predefined question of the one or more predefined questions may be modeled as a function definition associated with metadata specifying input parameters (which may be system defined or user defined) and one or more expected outputs. The LLM may be configured to use semantic search and/or fuzzy matching techniques to infer one or more closest matches between the one or more user queries and the one or more predefined questions.

At 1130, one or more clarifying prompts may be output. For example, the first instance of the LLM (e.g., the outer loop LLM) may be caused to output the one or more clarifying prompts. The one or more clarifying prompts may be caused to be output based on a determination that one or more of the one or more initial user inputs, one or more initial user intents and/or the one or more initial parameters are unclear or ambiguous. Determining the one or more initial user inputs, one or more initial user intents, and/or one or more initial parameters are unclear may comprise determining the one or more initial user inputs, the one or more initial user intents, and/or one or more parameters do not closely resemble (e.g., do not match) the one or more predefined questions in the question bank.

For example, determining that the one or more initial user inputs, one or more initial user intents, and/or one or more initial parameters are unclear may comprise determining that the one or more initial user inputs, the one or more initial user intents, and/or the one or more initial parameters do not satisfy a similarity threshold with respect to one or more predefined questions stored in a question bank. For example, the system may be configured to compare the one or more initial user inputs, intents, or parameters to a plurality of predefined questions using one or more natural language processing techniques, such as semantic matching, vector similarity analysis, or keyword-based heuristics. If a resulting similarity score falls below a predefined threshold, the system may determine that the user input is ambiguous, incomplete, or otherwise unclear. In some embodiments, determining that the user inputs are unclear may further comprise identifying that the user input does not match any predefined question with sufficient confidence (e.g., fails to meet a minimum match confidence score), or that the input lacks a sufficient number of contextual cues to allow unambiguous intent classification or parameter resolution.

Determining that the one or more initial user inputs, one or more initial user intents, and/or one or more initial parameters are unclear may comprise computing a similarity metric between a vector representation of the initial user input and a set of vector representations corresponding to a plurality of predefined questions stored in a question bank. The similarity metric (e.g., cosine similarity, Euclidean distance, or a learned embedding-space proximity function) may be used to determine a maximum similarity score. If the maximum similarity score is less than a predefined threshold, the system may determine that the initial user input is unclear or does not sufficiently correspond to any predefined question.

In certain embodiments, the vector may be derived via a text encoding model (e.g., a transformer-based sentence encoder), and the comparison operation may be configured to evaluate both syntactic and semantic similarity. Similarly, the determination that one or more user intents or parameters are unclear may be based on intent classification probabilities output by a trained model, wherein the maximum predicted intent class probability is less than a threshold. In some implementations, parameter clarity may be assessed using a coverage function that evaluates whether all required slots or arguments for a corresponding deterministic function or script are populated.

At 1140, one or second user inputs may be received. The one or more second user inputs may be received in response to the one or more clarifying prompts. The one or more second user inputs may comprise one or more second parameters associated with the one or more second user inputs. Similar to the one or more initial user inputs, the one or more second user inputs may be received by the LLM executing in the conversational outer loop via one or more of text input, voice input, combinations thereof, or the like. Determining one or more of the one or more initial user intents or the one or more second user intents may comprise determining one or more answers to one or more questions and joining the one or more answers.

At 1150, one or more second user intents may be determined. The one or more second user intents may be determined based on the one or more second user inputs and/or the one or more second user input parameters. The one or more second user intents may be determined by the LLM instance executing in the conversational outer loop. Determining the one or more user intents may comprise matching (based on the intent) the one or more user inputs to one or more predefined questions in a question bank. The one or more user intents may be determined by the outer loop LLM. The one or more predefined questions may be stored in (e.g., aggregated in) a question bank. For example, the outer loop may be configured to interpret user inputs (e.g., the one or more user queries) and map them to one or more “questions” in a curated question bank. For example, each predefined question of the one or more predefined questions may be modeled as a function definition associated with metadata specifying input parameters (which may be system defined or user defined) and one or more expected outputs. The LLM may be configured to use semantic search and/or fuzzy matching techniques to infer one or more closest matches between the one or more user queries and the one or more predefined questions.

The conversational outer loop may be configured to utilize the first instance of the large language model to clarify, by outputting one or more clarifying prompts configured to solicit one or more parameter values, one or more ambiguous user inputs and dynamically re-map the one or more initial user inputs to one or more of: the one or more chained predefined questions or the one or more deterministic scripts, wherein the one or more chained predefined questions are associated with the one or more deterministic scripts.

At 1160, one or more predefined questions may be determined. The one or more predefined questions may comprise one or more questions stored in the question bank. The one or more predefined questions may comprise one or more “chained” predefined questions. The one or more chained predefined questions may comprise a group of questions, wherein each question in the group of questions is associated with each other and wherein the group of questions is configured to determine one or more answers to the one or more initial user inputs and/or the one or more second user inputs. The one or more predefined questions in the question bank may be canonical. The one or more predefined questions in the question bank may be associated with one or more parameters (e.g., one or more pieces of information required to determine and output one or more answers to the one or more predefined questions) and/or one or more prompts configured to solicit additional information (e.g., missing parameters) from the user. The one or more predefined questions may be associated with role or persona restrictions, one or more expected output types, one or more pointers corresponding to one or more low level scripts, one or more optional links to fallback questions or related queries, combinations thereof, and the like.

The one or more predefined questions may be associated with one or more deterministic scripts. The one or more deterministic scripts may comprise one or more low level functions. The one or more low level functions may comprise one or more function calls configured to dictate how the system determines answers to user queries. In some cases, these scripts may be generated through the authoring workbench process and validated by subject matter experts before being added to the question bank. Function metadata may be made available and functions may be classified into one or more groups (e.g., “depot related functions,” “drug related functions,” etc., . . . ). During the authoring phase (as described below), a user may select one or more groups of functions to be available to generate the one or more predetermined scripts, which may be stored alongside each question may provide detailed information about the functions referenced in the associated script. In some cases, this metadata may include function names, input parameters, expected output formats, and any constraints or prerequisites for function execution. The question bank may implement versioning mechanisms to track changes to questions, scripts, and function metadata over time.

The method may comprise validating the one or more second user intents and the determination of the one or more chained predefined questions. The method may comprise executing, via the inner execution loop configured to execute the one or more deterministic scripts, according to the one or more deterministic scripts, one or more low level functions. The method may comprise, based on executing the one or more low level functions, sending, by the inner execution loop, to the first instance of the large language model associated with the conversational outer loop, one or more answers to the one or more chained predefined questions. The method may comprise validating, by a second instance of the large language model, the one or more answers generated by the inner execution loop. The method may comprise outputting, via the conversational interface, the one or more answers.

The one or more predefined questions may be aggregated in a question bank associated with an authoring workbench, wherein the authoring workbench is configured to allow one or more users to write one or more high level instructions and wherein the authoring workbench comprises a third instance of a large language model. The third instance of the LLM may be configured to receive the one or more high level instructions authored by one or more users and translate the one or more high level instructions into the one or more deterministic scripts.

The conversational outer loop may be configured to utilize the first instance of the large language model to clarify, by outputting one or more clarifying prompts configured to solicit one or more parameter values, one or more ambiguous user inputs and dynamically re-map the one or more initial user inputs to one or more of: the one or more chained predefined questions or the one or more deterministic scripts, wherein the one or more chained predefined questions are associated with the one or more deterministic scripts.

The one or more deterministic scripts may be generated based on one or more high level instructions authored by one or more subject matter experts and wherein the one or more deterministic scripts comprise one or more execution inner loop scripts configured to be executed in a controlled environment with a restricted and segmented chat history configured to prevent hallucinations by restricting interactions to predefined logic flows and a specified set of functions, the method further comprising translating, by an authoring workbench instance of the large language model, the one or more high level instructions into the one or more deterministic scripts which are configured to state a set of actions, wherein the set of actions and one or more large language model translations are configured to be validated by the one or more subject matter experts to validate that the large language model has produced a correct chain-of-thought reasoning.

The conversional virtual assistant system may comprise a test harness and wherein the test harness comprises an automated environment configured to compare a question bank against a sandbox instance of a target system, and wherein the test harness is configured to use one or more validation checks to determine the one or more initial user inputs or one or more second user inputs were answered correctly.

The method may comprise performing, by a separate large language model agent, a validation check associated with the inner execution loop, wherein the validation check associated with the inner execution loop is configured to ensure the one or more deterministic scripts were executed diligently. The method may comprise performing a validation check associated with the conversational outer loop, wherein the validation check associated with the conversational outer loop is configured to ensure the one or more initial user input parameters were correctly passed to the inner execution loop.

The method may comprise handling, on a segmented basis respectively for the conversational outer loop, the inner execution loop, and an authoring workbench, one or more large language model context window constraints.

The method may comprise dynamically updating a centralized question bank storing the one or more deterministic scripts and metadata configured to indicate one or more available functions, wherein the updating may occur without deploying new software via one or more new rules or via one or more new reports.

The method may comprise generating, via an authoring workbench system, and based on the metadata, one or more reports, wherein the one or more reports are configured to allow flexible extension of available data and the one or more available functions without system coding.

The method may comprise determining, based on one or more user identifiers associated with one or more of: the one or more initial user inputs or the one or more second user inputs, one or more persona based access controls, wherein the one or more persona based access controls are configured to restrict access to data, based on one or more unblinded designations associated with one or more personas or one or more blinded designations associated with the one or more personas, to one or more users.

The method may comprise accessing one or more distinct applications during a conversational session.

The method may comprise determining one or more languages associated with one or more of the one or more initial user inputs or the one or more second user inputs, wherein determining the one or more languages comprises one or more of performing a keyword localization or activating a multilingual support application.

The method may comprise generating, based on one or more of the one or more user queries, the one or more user intents, the one or more predefined questions, the one or more deterministic scripts, the one or more low level functions, the one or more user provided parameters, the one or more high level instructions, or the one or more answers, one or more auditable logs associated with one or more conversational sessions, wherein the one or more auditable logs are configured to provide one or more of retrospective validation or analysis of one or more question-answer flows. The method may comprise outputting, based on the one or more languages, one or more answers.

The method may comprise generating, based on one or more of the one or more initial user inputs, the one or more initial user intents, the one or more chained predefined questions, the one or more deterministic scripts, one or more low level functions, the one or more initial user input parameters, one or more high level instructions, or one or more answers, one or more auditable logs associated with one or more conversational sessions, wherein the one or more auditable logs are configured to provide one or more of retrospective validation or analysis of one or more question-answer flows.

The method may comprise determining, via a feedback mechanism, one or more unanswered user queries. The method may comprise determining, based on the one or more unanswered user queries, one or more system updates.

The method may determining, via a self-awareness application, and based on one or more personas and one or more application configurations, one or more available query functionalities. The method may comprise outputting, via a conversational interface, the one or more available query functionalities.

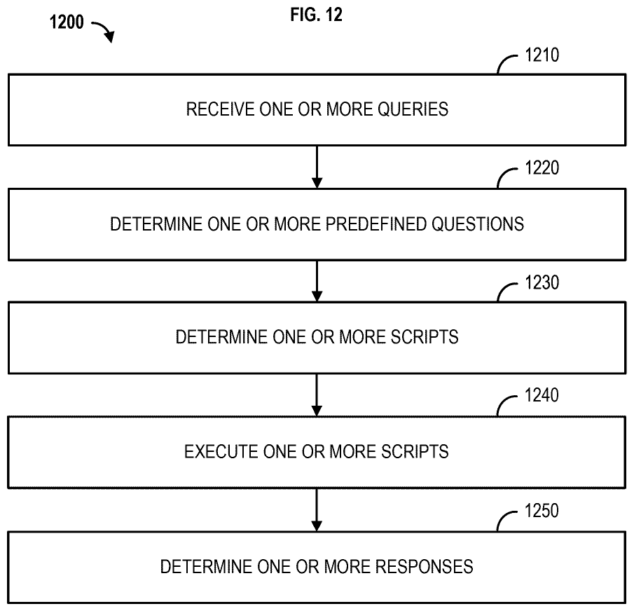

FIG. 12 shows an example method 1200. The method 1200 may be carried out via any one or more of the devices described here. At 1210 one or more user queries may be received. The one or more user queries may be received by a computing device. The computing device may be associated with a conversational outer loop as described herein. The computing device may comprise or otherwise be associated with a large language model (e.g., an outer loop LLM or a conversational LLM). The one or more user queries may be received via a conversational interface such as a chatbot. The one or more user queries may comprise one or more natural language user inputs. The one or more user queries may comprise one or more free form natural language user inputs. For example, the one or more user queries may be received via voice or text interface. The one or more user queries may also be referred to as “prompts” or “inputs.”

At 1220, one or more predefined questions may be determined. The one or more predefined questions may be determined based on the one or more user queries. For example, the computing device (e.g., the outer loop LLM) may determine one or more intents associated with the one or more user queries. The computing device and/or another computing device may determine, based on the intents associated with the one or more user queries, the one or more predefined questions. The one or more predefined questions may be stored in a question bank. The one or predefined questions may be configured to processing by the disclosed systems and methods.

At 1230, one or more scripts, one or more functions, one or more high level instructions, combinations thereof, and the like may be determined. The one or more scripts, one or more functions, and/or one or more high level instructions may be associated with the one or more predefined questions. For example, the one or more scripts may comprise the one or more functions. The one or more functions may comprise one or more functions calls configured to be executed by one or more devices associated with the inner loop as described herein.

At 1240, the one or more scripts and/or one or more functions may be executed. For example, executing the one or more scripts may comprise executing, or causing executing of the one or more functions in an ordered fashion. For example, the one or more scripts may be configured to determine the status of a drug order and/or determine why a drug order has not shipped. The aforementioned are merely exemplary and explanatory and a person skilled in the art will understand that the one or more scripts may comprise any combination of functions configured to determine any information.

The one or more functions may comprise one or more descriptions to the LLM of ways that the present system can retrieve information on its behalf using RAG. A function and its parameters and results may be described in detail to the LLM, and the LLM may be trained been trained to ask for a function to be called and the information provided back to it. For example, the system may call the function, then pass received information back to the LLM thereby enabling an agentic dialogue. The one or more low-level functions may also be referred to as plugins.

For example, each predetermined question from the question bank may be associated with a low-level execution script—a sequence of function calls that were authored and validated during the authoring phase. These scripts serve as deterministic workflows, instructing the LLM which functions to call, in what order, and how to thread outputs from one function into inputs for the next.

The functions themselves may reside (e.g., be stored) in a predetermined knowledge base (e.g., the IRT system's Functions Module) which exposes discrete API endpoints for operations such as retrieving drug request status, fetching site depot inventory, or checking subject randomization eligibility. The predetermined knowledge base may be associated with one or more clinical trials, one or more manufacturing processes, combinations thereof, and the like.

These functions are described via machine-readable metadata that includes their inputs, outputs, authorization requirements, and semantic descriptions. During the answering phase, only the relevant function metadata (e.g., those referenced in the low-level script) is exposed to the LLM, thereby reducing context window consumption and minimizing risk.

The one or more high level instructions may be used to gate or branch execution (e.g., ensuring that the function to release a shipment is only invoked if all prerequisite checks (e.g., signed informed consent, correct visit sequence) are passed). This rule-function linkage is may be enforced through the pre-authored script structure and the underlying validation of the rule logic.

The method may comprise orchestrating regulated, context-sensitive actions that are tightly coupled with validated procedural knowledge. This determination step builds upon the previously selected prompt(s) and evaluated high level instructions to map the user's intent to specific computational or workflow functions that operate in accordance with a defined body of domain knowledge.

For example, the system may retrieve or otherwise determine the one or more predefined questions, scripts, functions, and/or one or more applicable high level instructions (e.g., protocol-defined eligibility logic or GMP-compliant manufacturing checks). The system may be configured to evaluate those artifacts to determine which function or set of functions should be invoked. These functions may correspond to procedural tasks such as generating an eligibility report, triggering a subject enrollment module, initiating a deviation workflow, querying a lot release record, or scheduling a clinical visit within an electronic clinical outcomes assessment (eCOA) system. The mapping between question/rule combinations and actionable functions is predefined and governed by a structured knowledge base that encodes operational procedures, regulatory constraints, and protocol-specific logic.

The method may comprise using one or more identifiers associated with the one or more one or more user queries, one or more predefined questions, one or more scripts, one or more functions, one or more high level instructions, combinations thereof, and the like. For example, the system may be configured to use a query's intent identifier and the outcomes of the rule evaluations as keys to query a function map within the knowledge base. For example, a prompt that reads “Confirm subject 1042 meets inclusion criteria under protocol A123” and a business rule that confirms eligibility might collectively point to the function enrollSubject(subject_id, protocol_id). The knowledge base here may be implemented as a graph or table linking prompt identifiers, rule conditions, and corresponding function calls, each with metadata describing their operational scope, compliance conditions, audit requirements, and data dependencies.

These functions may include interfacing with external systems like EDC platforms, safety databases (e.g., Argus or ArisGlobal), randomization engines (e.g., IRT/RTSM systems), or trial master files to perform controlled actions. In pharmaceutical manufacturing, functions may initiate a batch release transaction, trigger an environmental excursion analysis, or push data to a validated batch record system. Functions are always subject to the constraints encoded in the underlying knowledge base, which may reflect GxP standards, SOPs, and system validation controls under FDA 21 CFR Part 11 or EU Annex 11.

At this point, the LLM is no longer operating in a free-form reasoning environment across an open-ended domain. Rather, it is constrained to a bounded set of function metadata that corresponds exactly to the functions referenced in the low-level script. This script, may be previously validated (e.g., by an artificial intelligence system or by a domain expert) during the authoring process and codified as the canonical resolution path for the matched user query.

To enable the LLM to execute these instructions within the RAG framework, the system may construct a specialized prompt that includes one or more of: a natural language wrapper describing the overall goal of the task (e.g., “Determine why drug request ID 20323 failed to generate on Apr. 9, 2024”), a structured representation of the function metadata (e.g., including names, expected parameters, output schemas, and semantic descriptions of each function, and/or the low-level script outlining the sequence in which the functions should be invoked, and any data dependencies between them).

This payload may be sent to the LLM, which may be configured to operate in an agentic, tool-augmented mode. Thus, at this stage, the LLM is responsible not necessarily for generating final answers, but primarily orchestrating RAG-based function calls by selecting which function to invoke next, constructing the appropriate parameters, and incorporating the returned data into its reasoning loop. The LLM may invoke each function via a call to a RESTful API exposed by the IRT's Functions Module and consume the returned JSON response, which is provided back into its conversational context.

This provides a technical advantage at least by, for example preserving token space. For example, by restricting the LLM's visibility only to the subset of functions required to resolve the user's specific question (e.g., as opposed to the full catalog of available functions) the system both preserves token space within the LLM's context window and enforces strict compliance with the validated resolution path. This system architecture and method, configured to create a selective visibility, also mitigates hallucination risk and ensure reliable, auditable, and deterministic behavior during the function orchestration phase. This architecture and method (e.g., the controlled RAG loop), provides for easy logging, validation, and fact-checking.

At 1250, based on executing the one or more scripts, one or more natural language responses (e.g., answers) may be determined. The one or more natural language responses may be received from the LLM operating the RAG framework. For example, after the large language model (LLM) has executed (or orchestrated the execution of) the specified low-level function calls via a retrieval augmented generation (RAG) process, the system proceeds to receive one or more natural language responses generated by the LLM. Unlike a free form LLM context, the response received from the RAG LLM, are generated from a tightly scoped, deterministic sequence of interactions with a predetermined knowledge base, namely the IRT function module and the associated trial-specific metadata. As the RAG process proceeds, the LLM receives structured JSON responses from the IRT system and uses them to populate a conversational context. This allows it to compose the one or more natural language response. For example, if the system determines that a drug request failed due to missing informed consent, the LLM may generate a response such as: “The drug request for subject 20323 on Apr. 9, 2024 failed to generate because the informed consent record had not yet been completed at the time of the request. Please ensure that all required documents are submitted before initiating the shipment workflow.”

Thus, the outputs are constrained and guided by the metadata and function responses it has been provided (e.g., the LLM is not fabricating answers from freeform inference, but is instead synthesizing outputs from a bounded, pre-authorized data space). Again, this provides a technical advantage because it greatly reduces hallucinations.

Additionally/alternatively, the one or more natural language responses may be passed through a fact-checking layer (which may be defined during the authoring phase). The fact checking layer may be configured to prompts the LLM to cross-validate its final message against a second reasoning path or logical checklist to further confirm correctness.

The method may comprise determining, generating, and/or maintaining one or more persona-based safeguards when generating responses. For example, the LLM may only receive data and generate content appropriate to the user's access level (e.g., such as enforcing blinded vs. unblinded roles) ensuring that sensitive or protocol-restricted information is not disclosed improperly. This may provide an advantage in maintaining compliance with Good Clinical Practice (GCP) and data privacy regulations.

The method may comprise outputting the one or more natural language responses. For example, the one or more natural language responses, having been derived from a tested and validated flow, may be displayed via a user interface module, optionally accompanied by visualizations (e.g., bar charts or tabular displays) centrally rendered in the UI engine.

The method may utilize a domain-specific orchestration layer or rule-based execution engine that evaluates the logic path associated with a prompt and rule context to determine a prioritized list of functions, including required input parameters and gating conditions. For example, a function to “release a lot” may only become available if the rule engine confirms all related CAPAs are closed and batch records are approved. Functions may be polymorphic-executing differently depending on user role, trial phase, region (e.g., EU vs. US compliance pathways), or therapeutic area.

For example, the method may make use of large language models (LLMs) or symbolic reasoning modules to contribute mapping functionality by synthesizing new or context-specific pathways based on regulatory knowledge and historic trial conduct. For example, given a prompt involving protocol deviation handling and corresponding rule validations, an LLM trained on deviation management SOPs and audit history may recommend invoking the function createDeviationRecord( ) while prepopulating fields based on entity extraction from the original query.

The present methods and systems reduce token load. For example, the present systems and methods may reduce token load by using deterministic low-level scripts, which are pre-authored and validated during the centralized authoring phase. Rather than relying on the LLM to dynamically generate reasoning chains at runtime, the system retrieves a compact, precompiled instruction set associated with a matched question, thereby avoiding the need to encode long chains of logic or multiple potential reasoning paths within the LLM prompt. These chains may be referred to as chain of thought, which is when the LLM is asked to describe the steps it would take to solve a problem, either directly in a response or indirectly via a step-by-step generation of responses and further prompts. It is the LLM version of reasoning.

The present methods and system may reduce token load may incorporating selective function metadata injection. When executing a low-level script, the LLM is only provided with metadata for the specific functions referenced in that script, as opposed to the full catalog of available functions. This approach dramatically reduces the volume of tokens dedicated to function schema descriptions—often one of the largest contributors to prompt size in agentic LLM systems.

The present systems and methods may reduce token load by incorporating context window pruning and compression techniques. During an active conversation, the system may consolidate earlier dialog turns into a compressed canonical form (e.g., replacing “User: My shipment on May 1st failed. LLM: Do you mean why didn't the shipment generate? User: Yes.” with a single QA pair summarizing the exchange). This helps keep the conversation history concise while retaining semantic continuity, enabling long-running user sessions to stay within context limits.

The system also avoids token-heavy free-form prompting during execution. By deferring free-form reasoning to the authoring phase and restricting runtime LLM use to parameter gathering, script execution, and result rendering, the system keeps each prompt lean, predictable, and context-aware, while retaining conversational fluency, and resulting in substantial savings in both computational cost and response latency.

Further, the use of RAG inherently reduces token load because it is scoped to top-ranked, semantically relevant documents or knowledge fragments. Instead of retrieving large document sections, the system may leverages embeddings to pull only the most relevant chunks (e.g., a single paragraph or subsection), limiting the volume of reference material injected into the prompt.

For example, when a user inputs a natural language query (e.g., “Why didn't my drug request go through?”), the system may invoke a large language model (LLM) in an agentic reasoning loop designed to interpret the query and map it to a supported question from a predefined question bank. This question bank is centrally authored and validated in advance by domain experts. Each entry in the question bank includes both a canonical prompt and a corresponding set of high level instructions that collectively define how to resolve that type of question in a deterministic, compliant manner.

The method may comprise interpreting queries related to protocol adherence, regulatory compliance, investigational product (IP) logistics, subject eligibility, adverse event reporting, or manufacturing deviation analysis. The method may comprise classifying the intent of the query using a domain-trained classifier (e.g., fine-tuned on regulatory documents, study protocols, and electronic data capture (EDC) forms). For example, the system may be configured to recognize that the query involves an eligibility determination, investigational product administration timing, or manufacturing quality control. Simultaneously, the system extracts structured entities, which may include subject demographics, lab results, investigational product batch numbers, or adverse event codes, depending on the context of the query.

The method may comprise retrieving, based on the classified intent and extracted entities, one or more preconfigured prompts configured to determine one or more regulated workflows (e.g., to confirm critical actions). The one or more preconfigured prompts may be domain-specific and pre-approved for use in validated systems—e.g., “Please confirm that subject 1042 has completed the baseline visit and passed all inclusion/exclusion criteria prior to randomization.” Prompt retrieval may rely on vector similarity matching using clinical context embeddings (e.g., from ClinicalBERT) or direct mapping via intent-code-to-template lookup. The system may also incorporate protocol-specific logic to tailor prompts based on the current phase of the trial, the therapeutic area, or site-specific amendments.

For example, determine which supported prompt is most appropriate, the LLM may engage in a dynamic, conversational back-and-forth with the user. This dialog may include clarifying questions or guided rephrasings until the input query can be confidently resolved to a known entry. Once matched, the system retrieves the canonical prompt (e.g., “Why did my drug request fail to generate?”) and any associated parameters that must be elicited from the user (e.g., date, request ID). At the same time, it retrieves the pre-authored business logic associated with that question, which may include conditional statements such as “if the site is unblinded and the shipment type is emergency, then check depot inventory,” each of which can be deterministically verified.

The method may comprise determining one or more applicable high level instructions (e.g., associated with regulatory schemes or otherwise protocol-derived) that must be evaluated before permitting or recommending further action. These rules may be stored in a clinical rules engine or governed by a validated quality management system (QMS). For example, a randomization query might trigger evaluation of rules verifying whether the subject has signed informed consent, passed all relevant eligibility checks, and completed all safety labs within the protocol-defined time window. In a manufacturing setting, a query like “Can I release batch B-1247 to packaging?” may invoke high level instructions verifying that all quality control (QC) tests have passed, deviations are resolved, and environmental monitoring results fall within acceptable thresholds.

The method may comprise dynamic rule evaluation which may depend on real-time access to source systems such as clinical trial management systems (CTMS), laboratory information systems (LIMS), electronic trial master files (eTMFs), or manufacturing execution systems (MES). Rules may also be contextualized based on user role—such as distinguishing between queries made by a site-level coordinator versus a global clinical operations lead or a manufacturing line operator versus a QA reviewer.

The method may comprise unifying intent recognition, prompt generation, and rule resolution into a single inference pipeline powered by a domain-adapted large language model (LLM). Such a model may be trained or fine-tuned on trial protocols, FDA and EMA regulations, GxP guidelines, and historical audit trails to generate compliant prompts and identify applicable SOP-driven decision rules. The model may output a structured response that includes both a proposed action (e.g., “Eligible for randomization”) and supporting documentation references (e.g., “per protocol A123, section 4.1.3”).

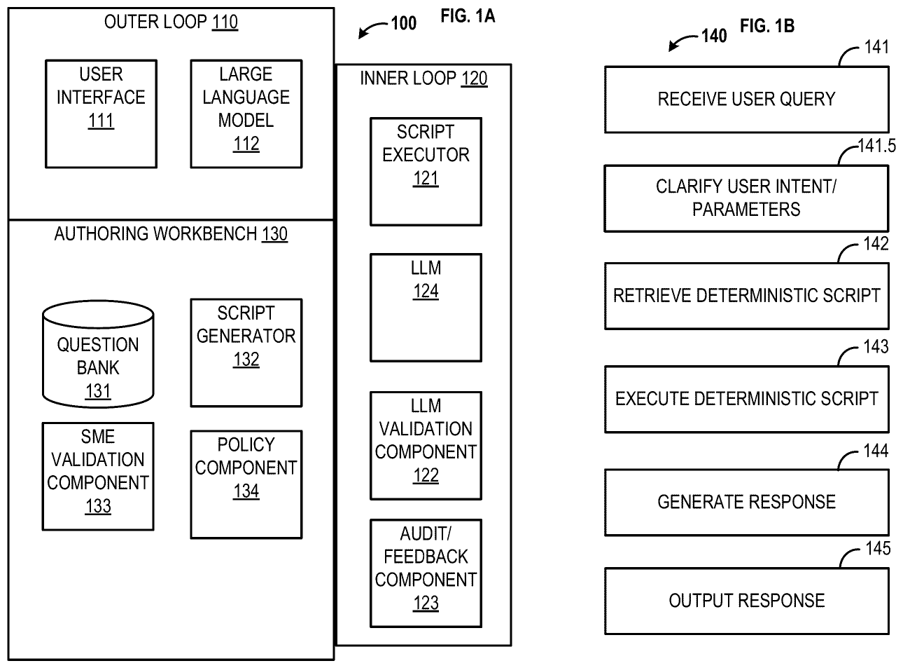

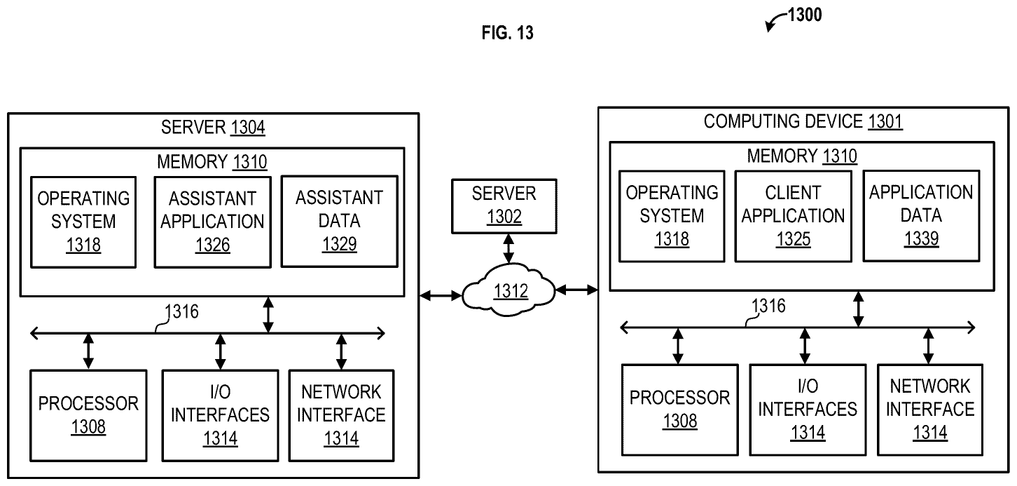

FIG. 13 shows a block diagram depicting a system/environment 1300 comprising non-limiting examples of a computing device 1301 and a server 1302 connected through a network 1304. Either of the computing device 1301 or the server 1302 may be a computing device, such as any of the devices of the system 100 shown in FIG. 1. In an aspect, some or all steps of any described method may be performed on a computing device as described herein. The computing device 1301 may comprise one or multiple computers configured to store application data 1339, and/or the like. The server 1302 may comprise one or multiple computers configured to store assistant data 1329. Multiple servers 1302 may communicate with the computing device 1301 via the through the network 1304.

The computing device 1301 and the server 1302 may be a digital computer that, in terms of hardware architecture, generally includes a processor 1308, system memory 1310, input/output (I/O) interfaces 1312, and network interfaces 1314. These components (608, 1310, 1312, and 1314) are communicatively coupled via a local interface 1316. The local interface 1316 may be, for example, but not limited to, one or more buses or other wired or wireless connections, as is known in the art. The local interface 1316 may have additional elements, which are omitted for simplicity, such as controllers, buffers (caches), drivers, repeaters, and receivers, to enable communications. Further, the local interface may include address, control, and/or connections to enable appropriate communications among the aforementioned components.

The processor 1308 may be a hardware device for executing software, particularly that stored in system memory 1310. The processor 1308 may be any custom made or commercially available processor, a central processing unit (CPU), an auxiliary processor among several processors associated with the computing device 1301 and the server 1302, a semiconductor-based microprocessor (in the form of a microchip or chip set), or generally any device for executing software instructions. When the computing device 1301 and/or the server 1302 is in operation, the processor 1308 may execute software stored within the system memory 1310, to communicate data to and from the system memory 1310, and to generally control operations of the computing device 1301 and the server 1302 pursuant to the software.

The I/O interfaces 1312 may be used to receive user input from, and/or for providing system output to, one or more devices or components. User input may be provided via, for example, a keyboard and/or a mouse. System output may be provided via a display device and a printer (not shown). I/O interfaces 1312 may include, for example, a serial port, a parallel port, a Small Computer System Interface (SCSI), an infrared (IR) interface, a radio frequency (RF) interface, and/or a universal serial bus (USB) interface.

The network interface 1314 may be used to transmit and receive from the computing device 1301 and/or the server 1302 on the network 1304. The network interface 1314 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 1314 may include address, control, and/or data connections to enable appropriate communications on the network 1304.

The system memory 1310 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 1310 may incorporate electronic, magnetic, optical, and/or other types of storage media. Note that the system memory 1310 may have a distributed architecture, where various components are situated remote from one another, but may be accessed by the processor 1308.

The software in system memory 1310 may include one or more software programs, each of which comprises an ordered listing of executable instructions for implementing logical functions. In the example of FIG. 13, the software in the system memory 1310 of the computing device 1301 may comprise the application data 1339, the client application 1325, and a suitable operating system (O/S) 1318. In the example of FIG. 13, the software in the system memory 1310 of the server 1302 may comprise the assistant data 1329, the assistant application 1326, and a suitable operating system (O/S) 1318. The operating system 1318 essentially controls the execution of other computer programs and provides scheduling, input-output control, file and data management, memory management, and communication control and related services.

For purposes of illustration, application programs and other executable program components such as the operating system 1318 are shown herein as discrete blocks, although it is recognized that such programs and components may reside at various times in different storage components of the computing device 1301 and/or the server 1302. An implementation of the system/environment 1300 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

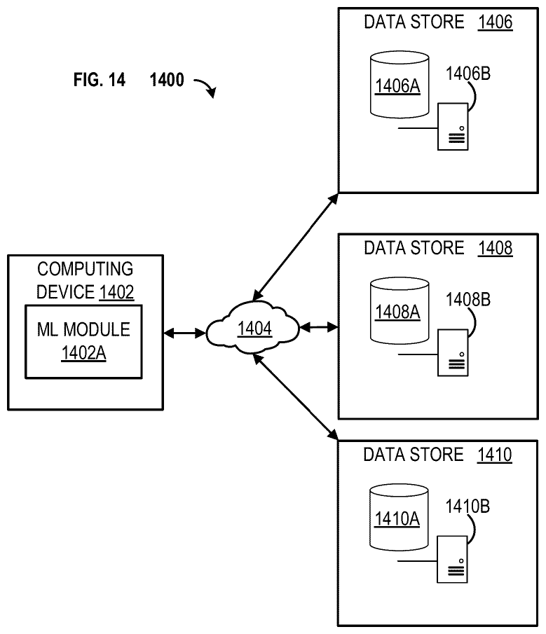

Turning now to FIG. 14, a block diagram of an example system 1400 is shown. The system 1400 may include a computing device 1402 and a plurality of data stores 1406, 1408, 1410 each in communication with the computing device 1402 via a network 1404. The computing device 1402 may comprise a Machine Learning (ML) module 1402A. The ML module 1402A may comprise and/or facilitate access to a plurality of ML models, such as at least one neural network, at least one Large Language Model (LLM), at least one segmentation model, at least one ensemble model, one or more combinations thereof, and/or the like. The LLM may comprise a neural network that can participate in conversational dialog.

Though the ML module 1402A is shown in FIG. 14 as being resident at the computing device 1402, it is to be understood that the ML module 1402A may be resident at one or more computing devices that may be local or remote to the computing device 1402. Each of the plurality of data stores 1406, 1408, 1410 may comprise one or more data storage mechanisms, such as a relational database, an in-memory data store, a log, or any other data storage repository configured for a retrieval interface. For ease of explanation, the plurality of data stores 1406, 1408, 1410 may be referred to herein as a “plurality of databases.” It is to be understood that any “database” referred to herein may comprise any type of suitable data storage mechanism.

The network 1404 may facilitate communication between the plurality of data stores 1406, 1408, 1410 and the computing device 1402. The network 1404 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent from any of the plurality of data stores 1406, 1408, 1410 to the computing device 1402 via a variety of transmission paths, including wireless paths (e.g., satellite paths, Wi-Fi paths, cellular paths, etc.) and terrestrial paths (e.g., wired paths, a direct feed source via a direct line, etc.). Additionally, data may be sent from the computing device 1402 to any of the plurality of data stores 1406, 1408, 1410 via a variety of transmission paths, including wireless paths and terrestrial paths.

The plurality of data stores 1406, 1408, 1410 may be part of a large data storage network consisting of numerous, disparate data stores. For example, the plurality of data stores 1406, 1408, 1410 may be used by an enterprise to store customer data. Each of the plurality of data stores 1406, 1408, 1410 may include a database 1406A, 1408A, 1410A, and a server 1406B, 1408B, 1410B. Each server 1406B, 1408B, 1410B may enable the computing device 1402 to communicate with, and retrieve data from, each of the databases 1406A, 1408A, 1410A. Each of the databases 1406A, 1408A, 1410A may be a different type of database. For example, the database 1406A may be an Oracle™ database, while the database 1408A may be a MySQL™ database. In some aspects, the ML module 1402A may access and process data from the databases 1406A, 1408A, 1410A. The data in these databases may be vectorized (e.g., unless the data is specifically identified by business-level keys). For example, drug request 1234 may not require vectorization but other structured and/or unstructured knowledge may require vectorization.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification. It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

What is claimed is:

1. A method for operating a conversional virtual assistant system comprising:
receiving, via a conversational interface, one or more initial user inputs and one or more initial user input parameters associated with the one or more initial user inputs;
determining, by a first instance of a large language model associated with a conversational outer loop, based on the one or more initial user inputs and the one or more initial user input parameters, one or more initial user intents associated with the one or more initial user inputs;
causing, by the first instance of the large language model, based on a determination that the one or more initial user intents and one or more initial user input parameters are unclear, the conversational interface to output one or more clarifying prompts, wherein the one or more clarifying prompts are configured to clarify the one or more initial user intents;
receiving, by the first instance of the large language model, in response to the one or more clarifying prompts, one or more second user inputs, wherein the one or more second user inputs comprise one or more second user input parameters;
determining, by the first instance of the large language model associated with the conversational outer loop, based on the one or more second user inputs, one or more second user intents associated with the one or more second user inputs and one or more second user input parameters; and
determining, based on the one or more second user intents and the one or more second user input parameters, and via an inner execution loop, one or more chained predefined questions, wherein the one or more chained predefined questions are associated with one or more deterministic scripts, and wherein the one or more deterministic scripts are configured to define one or more ordered sequences of one or more low level functions.

2. The method of claim 1, further comprising:
validating the one or more second user intents and the determination of the one or more chained predefined questions;
executing, via the inner execution loop configured to execute the one or more deterministic scripts, according to the one or more deterministic scripts, one or more low level functions;
based on executing the one or more low level functions, sending, by the inner execution loop, to the first instance of the large language model associated with the conversational outer loop, one or more answers to the one or more chained predefined questions;
validating, by a second instance of the large language model associated with an inner loop, the one or more answers generated by the inner execution loop; and
outputting, via the conversational interface, the one or more answers.

3. The method of claim 1, wherein the one or more predefined questions are aggregated in a question bank associated with an authoring workbench, wherein the authoring workbench is configured to allow one or more users to write one or more high level instructions and wherein the authoring workbench comprises a third instance of a large language model, and wherein the third instance of the large language model is configured to:
receive the one or more high level instructions authored by one or more users; and
translate the one or more high level instructions authored by the one or more users into one or more deterministic scripts.

4. The method of claim 1, wherein the conversational outer loop is configured to utilize the first instance of the large language model to clarify, by outputting one or more clarifying prompts configured to solicit one or more parameter values, one or more ambiguous user inputs and dynamically re-map the one or more initial user inputs to one or more of: the one or more chained predefined questions or the one or more deterministic scripts, wherein the one or more chained predefined questions are associated with the one or more deterministic scripts.

5. The method of claim 1, wherein the one or more deterministic scripts are generated based on one or more high level instructions authored by one or more subject matter experts and wherein the one or more deterministic scripts comprise one or more execution inner loop scripts configured to be executed in a controlled environment with a restricted and segmented chat history configured to prevent hallucinations by restricting interactions to predefined logic flows and a specified set of functions, the method further comprising translating, by an authoring workbench instance of the large language model, the one or more high level instructions into the one or more deterministic scripts which are configured to state a set of actions, wherein the set of actions and one or more large language model translations are configured to be validated by the one or more subject matter experts to validate that the large language model has produced a correct chain-of-thought reasoning.

6. The method of claim 1, wherein the conversional virtual assistant system comprises a test harness and wherein the test harness comprises an automated environment configured to compare a question bank against a sandbox instance of a target system, and wherein the test harness is configured to use one or more validation checks to determine the one or more initial user inputs or one or more second user inputs were answered correctly.

7. The method of claim 1, further comprising:
performing, by a separate large language model agent, a validation check associated with the inner execution loop, wherein the validation check associated with the inner execution loop is configured to ensure the one or more deterministic scripts were executed diligently; and
performing a validation check associated with the conversational outer loop, wherein the validation check associated with the conversational outer loop is configured to ensure the one or more initial user input parameters were correctly passed to the inner execution loop.

8. The method of claim 1, further comprising handling, on a segmented basis respectively for the conversational outer loop, the inner execution loop, and an authoring workbench, one or more large language model context window constraints.

9. The method of claim 1, wherein determining one or more of the one or more initial user intents or the one or more second user intents comprises determining one or more answers to one or more questions and joining the one or more answers.

10. The method of claim 1, further comprising dynamically updating a centralized question bank storing the one or more deterministic scripts and metadata configured to indicate one or more available functions, wherein the updating may occur without deploying new software via one or more new rules or via one or more new reports.

11. The method of claim 10, further comprising generating, via an authoring workbench system, and based on the metadata, one or more reports, wherein the one or more reports are configured to allow flexible extension of available data and the one or more available functions without system coding.

12. The method of claim 1, further comprising determining, based on one or more user identifiers associated with one or more of: the one or more initial user inputs or the one or more second user inputs, one or more persona based access controls, wherein the one or more persona based access controls are configured to restrict access to data, based on one or more unblinded designations associated with one or more personas or one or more blinded designations associated with the one or more personas, to one or more users.

13. The method of claim 1, further comprising accessing one or more distinct applications during a conversational session.

14. The method of claim 1, further comprising:
determining one or more languages associated with one or more of the one or more initial user inputs or the one or more second user inputs, wherein determining the one or more languages comprises one or more of performing a keyword localization or activating a multilingual support application; and
outputting, based on the one or more languages, one or more answers.

15. The method of claim 1, further comprising generating, based on one or more of the one or more initial user inputs, the one or more initial user intents, the one or more chained predefined questions, the one or more deterministic scripts, one or more low level functions, the one or more initial user input parameters, one or more high level instructions, or one or more answers, one or more auditable logs associated with one or more conversational sessions, wherein the one or more auditable logs are configured to provide one or more of retrospective validation or analysis of one or more question-answer flows.

16. The method of claim 1, further comprising:
determining, via a feedback mechanism, one or more unanswered user queries; and
determining, based on the one or more unanswered user queries, one or more system updates.

17. The method of claim 1, further comprising:
determining, via a self-awareness application, and based on one or more personas and one or more application configurations, one or more available query functionalities; and
outputting, via a conversational interface, the one or more available query functionalities.

18. An apparatus comprising:
one or more processors; and
memory storing processor executable instructions that, when executed by the one or more processors, cause the one or more processors to:
receive, via a conversational interface, one or more initial user inputs and one or more initial user input parameters associated with the one or more initial user inputs;
determine, by a first instance of a large language model associated with a conversational outer loop, based on the one or more initial user inputs and the one or more initial user input parameters, one or more initial user intents associated with the one or more initial user inputs;
cause, by the first instance of the large language model, based on a determination that the one or more initial user intents and one or more initial user input parameters are unclear, the conversational interface to output one or more clarifying prompts, wherein the one or more clarifying prompts are configured to clarify the one or more initial user intents;
receive, by the first instance of the large language model, in response to the one or more clarifying prompts, one or more second user inputs, wherein the one or more second user inputs comprise one or more second user input parameters;
determine, by the first instance of the large language model associated with the conversational outer loop, based on the one or more second user inputs, one or more second user intents associated with the one or more second user inputs and one or more second user input parameters; and
determine, based on the one or more second user intents and the one or more second user input parameters, and via an inner execution loop, one or more chained predefined questions, wherein the one or more chained predefined questions are associated with one or more deterministic scripts, and wherein the one or more deterministic scripts are configured to define one or more ordered sequences of one or more low level functions.

19. The apparatus of claim 18, wherein the processor executable instructions, when executed by the one or more processors, further cause the one or more processors to:
validate the one or more second user intents and the determination of the one or more chained predefined questions;
execute, via the inner execution loop configured to execute the one or more deterministic scripts, according to the one or more deterministic scripts, one or more low level functions;
based on executing the one or more low level functions, send, by the inner execution loop, to the first instance of the large language model associated with the conversational outer loop, one or more answers to the one or more chained predefined questions;
validate, by a second instance of the large language model associated with an inner loop, the one or more answers generated by the inner execution loop; and
output, via the conversational interface, the one or more answers.

20. The apparatus of claim 18, wherein the one or more chained predefined questions are aggregated in a question bank associated with an authoring workbench, wherein the authoring workbench is configured to allow one or more users to write one or more high level instructions and wherein the authoring workbench comprises a third instance of a large language model, and wherein the third instance of the large language model is configured to:
receive the one or more high level instructions authored by one or more users; and
translate the one or more high level instructions authored by the one or more users into one or more deterministic scripts.

21. The apparatus of claim 18, wherein the conversational outer loop is configured to utilize the first instance of the large language model to clarify, by outputting one or more clarifying prompts configured to solicit one or more parameter values, one or more ambiguous user inputs and dynamically re-map the one or more initial user inputs to one or more of: the one or more chained predefined questions or the one or more deterministic scripts, wherein the one or more chained predefined questions are associated with the one or more deterministic scripts.

22. The apparatus of claim 18, wherein the one or more deterministic scripts are generated based on one or more high level instructions authored by one or more subject matter experts and wherein the one or more deterministic scripts comprise one or more execution inner loop scripts configured to be executed in a controlled environment with a restricted and segmented chat history configured to prevent hallucinations by restricting interactions to predefined logic flows and a specified set of functions, the method further comprising translating, by an authoring workbench instance of the large language model, the one or more high level instructions into the one or more deterministic scripts which are configured to state a set of actions, wherein the set of actions and one or more large language model translations are configured to be validated by the one or more subject matter experts to validate that the large language model has produced a correct chain-of-thought reasoning.

23. The apparatus of claim 18, wherein the conversional virtual assistant system comprises a test harness and wherein the test harness comprises an automated environment configured to compare a question bank against a sandbox instance of a target system, and wherein the test harness is configured to use one or more validation checks to determine the one or more initial user inputs or one or more second user inputs were answered correctly.

24. The apparatus of claim 18, wherein the processor executable instructions, when executed by the one or more processors, further cause the one or more processors to:
perform, by a separate large language model agent, a validation check associated with the inner execution loop, wherein the validation check associated with the inner execution loop is configured to ensure the one or more deterministic scripts were executed diligently; and
perform a validation check associated with the conversational outer loop, wherein the validation check associated with the conversational outer loop is configured to ensure the one or more initial user input parameters were correctly passed to the inner execution loop.

25. The apparatus of claim 18, wherein the processor executable instructions, when executed by the one or more processors, further cause the one or more processors to handle, on a segmented basis respectively for the conversational outer loop, the inner execution loop, and an authoring workbench, one or more large language model context window constraints.

26. The apparatus of claim 18, wherein the processor executable instructions, that, when executed by the one or more processors, cause the one or more processors to determine one or more of the one or more initial user intents or the one or more second user intents, further cause the one or more processors to determine one or more answers to one or more questions and joining the one or more answers.

27. The apparatus of claim 18, wherein the processor executable instructions, when executed by the one or more processors, further cause the one or more processors to dynamically update a centralized question bank storing the one or more deterministic scripts and metadata configured to indicate one or more available functions, wherein the updating may occur without deploying new software via one or more new rules or via one or more new reports.

28. The apparatus of claim 27, wherein the processor executable instructions, when executed by the one or more processors, further cause the one or more processors to generate, via an authoring workbench system, and based on the metadata, one or more reports, wherein the one or more reports are configured to allow flexible extension of available data and the one or more available functions without system coding.

29. The apparatus of claim 18, wherein the processor executable instructions, when executed by the one or more processors, further cause the one or more processors to determine, based on one or more user identifiers associated with one or more of: the one or more initial user inputs or the one or more second user inputs, one or more persona based access controls, wherein the one or more persona based access controls are configured to restrict access to data, based on one or more unblinded designations associated with one or more personas or one or more blinded designations associated with the one or more personas, to one or more users.

30. The apparatus of claim 18, wherein the processor executable instructions, when executed by the one or more processors, further cause the one or more processors to access one or more distinct applications during a conversational session.

31. The apparatus of claim 18, wherein the processor executable instructions, when executed by the one or more processors, further cause the one or more processors to:
determine one or more languages associated with one or more of the one or more initial user inputs or the one or more second user inputs, wherein determining the one or more languages comprises one or more of performing a keyword localization or activating a multilingual support application; and
output, based on the one or more languages, one or more answers.

32. The apparatus of claim 18, wherein the processor executable instructions, when executed by the one or more processors, further cause the one or more processors to generate, based on one or more of the one or more initial user inputs, the one or more initial user intents, the one or more chained predefined questions, the one or more deterministic scripts, one or more low level functions, the one or more initial user input parameters, one or more high level instructions, or one or more answers, one or more auditable logs associated with one or more conversational sessions, wherein the one or more auditable logs are configured to provide one or more of retrospective validation or analysis of one or more question-answer flows.

33. The apparatus of claim 18, wherein the processor executable instructions, when executed by the one or more processors, further cause the one or more processors to:
determine, via a feedback mechanism, one or more unanswered user queries; and
determine, based on the one or more unanswered user queries, one or more system updates.

34. The apparatus of claim 18, wherein the processor executable instructions, when executed by the one or more processors, further cause the one or more processors to:
determine, via a self-awareness application, and based on one or more personas and one or more application configurations, one or more available query functionalities; and
output, via a conversational interface, the one or more available query functionalities.

35. One or more non-transitory computer-readable media storing processor-executable instructions thereon, which, when executed by at least one processor cause the at least one processor to:
receive, via a conversational interface, one or more initial user inputs and one or more initial user input parameters associated with the one or more initial user inputs;
determine, by a first instance of a large language model associated with a conversational outer loop, based on the one or more initial user inputs and the one or more initial user input parameters, one or more initial user intents associated with the one or more initial user inputs;
cause, by the first instance of the large language model, based on a determination that the one or more initial user intents and one or more initial user input parameters are unclear, the conversational interface to output one or more clarifying prompts, wherein the one or more clarifying prompts are configured to clarify the one or more initial user intents;
receive, by the first instance of the large language model, in response to the one or more clarifying prompts, one or more second user inputs, wherein the one or more second user inputs comprise one or more second user input parameters;
determine, by the first instance of the large language model associated with the conversational outer loop, based on the one or more second user inputs, one or more second user intents associated with the one or more second user inputs and one or more second user input parameters; and
determine, based on the one or more second user intents and the one or more second user input parameters, and via an inner execution loop, one or more chained predefined questions, wherein the one or more chained predefined questions are associated with one or more deterministic scripts, and wherein the one or more deterministic scripts are configured to define one or more ordered sequences of one or more low level functions.

36. The one or more non-transitory computer-readable media of claim 35, wherein processor-executable instructions, when executed by at least one processor, further cause the at least one processor to:
validate the one or more second user intents and the determination of the one or more chained predefined questions;
execute, via the inner execution loop configured to execute the one or more deterministic scripts, according to the one or more deterministic scripts, one or more low level functions;
based on executing the one or more low level functions, send, by the inner execution loop, to the first instance of the large language model associated with the conversational outer loop, one or more answers to the one or more chained predefined questions;
validate, by a second instance of the large language model associated with an inner loop, the one or more answers generated by the inner execution loop; and
output, via the conversational interface, the one or more answers.

37. The one or more non-transitory computer-readable media of claim 35, wherein the one or more chained predefined questions are aggregated in a question bank associated with an authoring workbench, wherein the authoring workbench is configured to allow one or more users to write one or more high level instructions and wherein the authoring workbench comprises a third instance of a large language model, and wherein the third instance of the large language model is configured to:
receive the one or more high level instructions authored by one or more users; and
translate the one or more high level instructions authored by the one or more users into one or more deterministic scripts.

38. The one or more non-transitory computer-readable media of claim 35, wherein the conversational outer loop is configured to utilize the first instance of the large language model to clarify, by outputting one or more clarifying prompts configured to solicit one or more parameter values, one or more ambiguous user inputs and dynamically re-map the one or more initial user inputs to one or more of: the one or more chained predefined questions or the one or more deterministic scripts, wherein the one or more chained predefined questions are associated with the one or more deterministic scripts.

39. The one or more non-transitory computer-readable media of claim 35, wherein the one or more deterministic scripts are generated based on one or more high level instructions authored by one or more subject matter experts and wherein the one or more deterministic scripts comprise one or more execution inner loop scripts configured to be executed in a controlled environment with a restricted and segmented chat history configured to prevent hallucinations by restricting interactions to predefined logic flows and a specified set of functions, the method further comprising translating, by an authoring workbench instance of the large language model, the one or more high level instructions into the one or more deterministic scripts which are configured to state a set of actions, wherein the set of actions and one or more large language model translations are configured to be validated by the one or more subject matter experts to validate that the large language model has produced a correct chain-of-thought reasoning.

40. The one or more non-transitory computer-readable media of claim 35, wherein the conversional virtual assistant system comprises a test harness and wherein the test harness comprises an automated environment configured to compare a question bank against a sandbox instance of a target system, and wherein the test harness is configured to use one or more validation checks to determine the one or more initial user inputs or one or more second user inputs were answered correctly.

41. The one or more non-transitory computer-readable media of claim 35, wherein the processor-executable instructions, when executed by the at least one processor further cause the at least one processor to:
Perform, by a separate large language model agent, a validation check associated with the inner execution loop, wherein the validation check associated with the inner execution loop is configured to ensure the one or more deterministic scripts were executed diligently; and
perform a validation check associated with the conversational outer loop, wherein the validation check associated with the conversational outer loop is configured to ensure the one or more initial user input parameters were correctly passed to the inner execution loop.

42. The one or more non-transitory computer-readable media of claim 35, wherein the processor-executable instructions, when executed by the at least one processor further cause the at least one processor to handle, handle, on a segmented basis respectively for the conversational outer loop, the inner execution loop, and an authoring workbench, one or more large language model context window constraints.

43. The one or more non-transitory computer-readable media of claim 35, wherein the processor-executable instructions, that, when executed by the at least one processor cause the at least one processor to determine one or more of the one or more initial user intents or the one or more second user intents, further cause the one or more processors to determine one or more answers to one or more questions and joining the one or more answers.

44. The one or more non-transitory computer-readable media of claim 35, wherein the processor-executable instructions, when executed by the at least one processor further cause the at least one processor to dynamically update a centralized question bank storing the one or more deterministic scripts and metadata configured to indicate one or more available functions, wherein the updating may occur without deploying new software via one or more new rules or via one or more new reports.

45. The one or more non-transitory computer-readable media of claim 44, wherein the processor-executable instructions, when executed by the at least one processor further cause the at least one processor to generate, via an authoring workbench system, and based on the metadata, one or more reports, wherein the one or more reports are configured to allow flexible extension of available data and the one or more available functions without system coding.

46. The one or more non-transitory computer-readable media of claim 35, wherein the processor-executable instructions, when executed by the at least one processor further cause the at least one processor to determine, based on one or more user identifiers associated with one or more of: the one or more initial user inputs or the one or more second user inputs, one or more persona based access controls, wherein the one or more persona based access controls are configured to restrict access to data, based on one or more unblinded designations associated with one or more personas or one or more blinded designations associated with the one or more personas, to one or more users.

47. The one or more non-transitory computer-readable media of claim 35, wherein the processor-executable instructions, when executed by the at least one processor further cause the at least one processor to access one or more distinct applications during a conversational session.

48. The one or more non-transitory computer-readable media of claim 35, wherein the processor-executable instructions, when executed by the at least one processor further cause the at least one processor to:
determine one or more languages associated with one or more of the one or more initial user inputs or the one or more second user inputs, wherein determining the one or more languages comprises one or more of performing a keyword localization or activating a multilingual support application; and
output, based on the one or more languages, one or more answers.

49. The one or more non-transitory computer-readable media of claim 35, wherein the processor-executable instructions, when executed by the at least one processor further cause the at least one processor to generate, based on one or more of the one or more initial user inputs, the one or more initial user intents, the one or more chained predefined questions, the one or more deterministic scripts, one or more low level functions, the one or more initial user input parameters, one or more high level instructions, or one or more answers, one or more auditable logs associated with one or more conversational sessions, wherein the one or more auditable logs are configured to provide one or more of retrospective validation or analysis of one or more question-answer flows.

50. The one or more non-transitory computer-readable media of claim 35, wherein the processor-executable instructions, when executed by the at least one processor further cause the at least one processor to:
determine, via a feedback mechanism, one or more unanswered user queries; and
determine, based on the one or more unanswered user queries, one or more system updates.

51. The one or more non-transitory computer-readable media of claim 35, wherein the processor-executable instructions, when executed by the at least one processor further cause the at least one processor to:
determine, via a self-awareness application, and based on one or more personas and one or more application configurations, one or more available query functionalities; and
output, via a conversational interface, the one or more available query functionalities.
